(19) United States
(12) Patent Application Publication
(10) Pub. No.: US 2017/0372865 A1
(43) Pub. Date: Dec. 28, 2017

(54) X-RAY TUBE DEVICE

(71) Applicant: Toshiba Electron Tubes & Devices Co., Ltd., Otawara-shi (JP)

(72) Inventors: Tomonari ISHIHARA, Otawara (JP); Hidero ANNO, Otawara (JP)

(73) Assignee: Toshiba Electron Tubes & Devices Co., Ltd., Otawara-shi (JP)

(21) Appl. No.: 15/686,853

(22) Filed: Aug. 25, 2017

Related U.S. Application Data
(63) Continuation of application No. PCT/JP2016/052138, filed on Jan. 26, 2016.

(30) Foreign Application Priority Data
Feb. 27, 2015 (JP) 2015-037842

(51) Int. Cl. H01J 35/14; H01J 35/16; H01J 35/06; H01J 35/30; H01J 35/10

(52) U.S. Cl. CPC H01J 35/14; H01J 35/30; H01J 35/106; H01J 35/06; H01J 35/16; H01J 2235/1204; H01J 2235/18

(57) ABSTRACT

According to one embodiment, an X-ray tube device includes a cathode which emits an electron in a direction of an electron path, an anode target which faces the cathode and includes a target surface generating an X-ray, a vacuum envelope which accommodates the cathode and the anode target and is sealed in a vacuum-tight manner, and a quadrupole magnetic field generation unit which forms a magnetic field when direct current is supplied from an electric source, is eccentrically provided with respect to a straight line accordance with the electron path outside the vacuum envelope, and includes a quadrupole surrounding a circumference of a part of the electron path.

### CROSS-REFERENCE TO RELATED APPLICATIONS

This application is a Continuation Application of PCT Application No. PCT/JP2016/052138, filed Jan. 26, 2016 and based upon and claiming the benefit of priority from Japanese Patent Application No. 2015-037842, filed Feb. 27, 2015, the entire contents of all of which are incorporated herein by reference.

### FIELD

Embodiments described herein relate generally to an X-ray tube device.

### BACKGROUND

A rotating anode X-ray tube device is a device which causes electrons generated from the electron generation source of a cathode to collide with a rotating anode target and generates X-rays from the X-ray focal spot formed by the collision of the electrons of the anode target. In general, the rotating anode X-ray tube device is used for an X-ray computed tomography (CT) device, etc.

In general, the rotating anode X-ray tube device forms the focal spot of electron beams in different sizes on the anode target based on the purpose. Thus, the rotating anode X-ray tube device comprises a filament corresponding to the shape of the focal spot to be formed, and a focusing groove provided in a cathode cup for accommodating the filament. As a technology which continuously changes the size of the focal spot in a broader range, for example, a structure of changing a circular electron beam to a linear focal spot with a quadrupole magnetic field is known.

The reference related to the above technology is shown below, and the entire contents of which are incorporated herein by reference.

### BRIEF DESCRIPTION OF THE DRAWINGS

FIG. 1 is a cross-sectional view showing an example of an X-ray tube device according to a first embodiment.

FIG. 2A is a cross-sectional view showing the general outline of an X-ray tube according to the first embodiment.

FIG. 2B is a cross-sectional view taken along line IIA-IIA of FIG. 2A.

FIG. 2C is a cross-sectional view taken along line IIB-IIB of FIG. 2B.

FIG. 3 is a cross-sectional view showing the principle of a quadrupole magnetic field generation unit according to the first embodiment.

FIG. 4 is a cross-sectional view showing the general outline of an X-ray tube according to a second embodiment.

FIG. 5A shows the principle of a dipole magnetic field according to the second embodiment.

FIG. 5B shows the principle of a quadrupole magnetic field generation unit according to the second embodiment.

FIG. 6A shows the general outline of the X-ray tube according to modification example 1 of the second embodiment.

FIG. 6B is a cross-sectional view taken along line VIA-VIA of FIG. 6A.

FIG. 7A is a cross-sectional view showing the principle of a quadrupole magnetic field according to modification example 1 of the second embodiment.

FIG. 7B is a cross-sectional view showing the principle of a dipole magnetic field according to modification example 1 of the second embodiment.

FIG. 7C is a cross-sectional view showing the principle of the quadrupole magnetic field generation unit according to modification example 1 of the second embodiment.

FIG. 8 is a cross-sectional view showing the general outline of the X-ray tube according to modification example 2 of the second embodiment.

FIG. 9 is a cross-sectional view taken along line VIII-VIII of FIG. 8.

FIG. 10 is a cross-sectional view showing an example of an X-ray tube device according to a third embodiment.

FIG. 11A is a cross-sectional view showing the general outline of an X-ray tube according to the third embodiment.

FIG. 11B is a cross-sectional view taken along line XIA-XIA of FIG. 11A.

FIG. 11C is a cross-sectional view taken along line XIB1-XIB1 of FIG. 11B.

FIG. 11D is a cross-sectional view taken along line XIB2-XIB2 of FIG. 11B.

FIG. 11E is a cross-sectional view taken along line XID-XID of FIG. 11D.

FIG. 12A is a cross-sectional view showing the principle of a quadrupole magnetic field according to the third embodiment.

FIG. 12B is a cross-sectional view showing the principle of dipoles according to the third embodiment.

### DETAILED DESCRIPTION

In general, according to one embodiment, an X-ray tube device comprises: a cathode which emits an electron in a direction of an electron path; an anode target which faces the cathode and comprises a target surface generating an X-ray when the electron emitted from the cathode collides with the target surface; a vacuum envelope which accommodates the cathode and the anode target and is sealed in a vacuum-tight manner; and a quadrupole magnetic field generation unit which forms a magnetic field when direct current is supplied from an electric source, is eccentrically provided with respect to a straight line accordance with the electron path outside the vacuum envelope, and comprises a quadrupole surrounding a circumference of a part of the electron path.

Various embodiments of an X-ray tube device are explained in detail below with reference to the accompanying drawings.

### First Embodiment

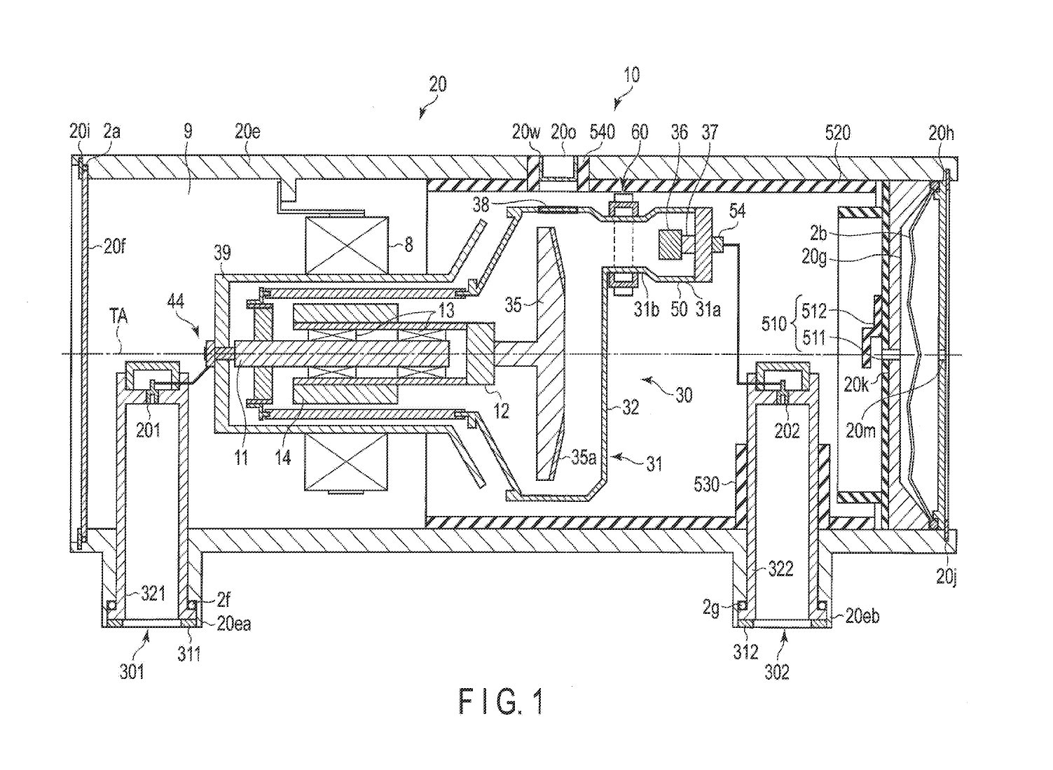

FIG. 1 is a cross-sectional view showing an example of an X-ray tube device 10 according to a first embodiment.

As shown in FIG. 1, the X-ray tube device 10 of the first embodiment roughly comprises a stator coil 8, a housing 20, an X-ray tube 30, a high-voltage insulating member 39, a quadrupole magnetic field generation unit 60, receptacles 301 and 302, and X-ray shielding units 510, 520, 530 and 540. For example, the X-ray tube device 10 is a rotating anode-side X-ray tube device. The X-ray tube 30 is, for example, a rotating anode X-ray tube. For example, the X-ray tube 30 is a neutral grounded rotating anode X-ray tube. X-ray shielding units 510, 520, 530 and 540 are formed of lead.

In the X-ray tube device 10, an insulating oil 9 which is a coolant fills a space defined between the inner side of housing 20 and the external side of the X-ray tube 30. For example, the X-ray tube device 10 is configured to circulate the insulating oil 9 by a cyclic cooling system (cooler; not shown) connected to housing 20 by hose (not shown) for refrigeration. In this case, housing 20 comprises an inlet and an outlet for the insulating oil 9. The cyclic cooling system comprises, for example, a cooler which causes the insulating oil 9 in housing 20 to release heat and circulate, and a duct (hose, etc.,) connecting the cooler to the inlet and outlet of housing 20 in a liquid-tight and air-tight manner. The cooler comprises a circulation pump and a heat exchanger. The circulation pump discharges the insulating oil 9 taken in from the housing 20 side to the heat exchanger, and produces the flow of the insulating oil 9 inside housing 20. The heat exchanger is connected between housing 20 and the circulation pump, and releases the heat of the insulating oil 9 to outside.

Now, this specification explains the detailed structure of the X-ray tube device 10 with reference to the accompanying drawings.

Housing 20 comprises a tubular housing main unit 20e, and cover units (side plates) 20f, 20g and 20h. The housing main unit 20e and cover units 20f, 20g and 20h are formed by casting with aluminum. When a resinous material is used, metal may be also partially used for, for example, a portion which should be strong, such as a screw portion, a portion which is hardly manufactured by injection molding with resin, or a shielding layer (not shown) which prevents electromagnetic noise from leaking out to the outside of housing 20. The central axis passing through the center of the circle of the cylinder of the housing main unit 20e is defined as a tube axis TA.

The housing main unit 20e comprises an aperture portion comprising an annular step portion formed as an inner circumferential surface having a wall thickness less than the wall thickness of the housing main unit 20e. An annular groove portion is formed along the inner circumference of the step portion. The groove portion of the housing main unit 20e is manufactured by cutting at the position of a predetermined length from the step of the step portion to the external side along the tube axis TA. The predetermined length is, for example, a length substantially equal to the thickness of cover unit 20f. A C-shaped snap ring 20i fits in the groove portion of the housing main unit 20e. The aperture portion of the housing main unit 20e is sealed in a liquid-tight manner by cover unit 20f and C-shaped snap ring 20i, etc.

Cover unit 20f is shaped like a disk. A rubber member 2a is provided along the outer circumferential portion of cover unit 20f. Cover unit 20f fits in the step portion formed in the aperture portion of the housing main unit 20e.

Rubber member 2a has, for example, an O-ring shape. As stated above, rubber member 2a is provided between the housing main unit 20e and cover unit 20f, and seals the space between the housing main unit 20e and cover unit 20f in a liquid-tight manner. The peripheral portion of cover unit 20f is in contact with the step portion of the housing main unit 20e in a direction parallel to the tube axis TA of the X-ray tube device 10.

C-shaped snap ring 20i is a fixing member. C-shaped snap ring 20i fits in the groove portion of the housing main unit 20e as described above and fixes cover unit 20f to prevent cover unit 20f from moving in a direction parallel to the tube axis TA.

In an aperture portion on a side opposite to the aperture portion of the housing main unit 20e in which cover unit 20f is provided, cover units 20g and 20h fit. Cover units 20g and 20h are provided parallel to cover unit 20f so as to face each other at an end portion on a side opposite to the end portion of the housing main unit 20e in which cover unit 20f is provided. Cover unit 20g fits in a predetermined portion inside the housing main unit 20e, and is provided in a liquid-tight manner. At the end portion of the housing main unit 20e at which cover unit 20h is provided, an annular groove portion is formed in the inner circumferential portion of the external side adjacent to the installation position of cover unit 20h. A rubber member 2b is provided between cover units 20g and 20h so as to retain the liquid-tight state such that rubber member 2b is expandable and shrinkable. Cover unit 20h is provided on the external side in the housing main unit 20e in comparison with cover unit 20g. In this groove portion, a C-shaped snap ring 20j fits. Thus, the aperture portion of the housing main unit 20e is sealed by cover units 20g and 20h, C-shaped snap ring 20j, rubber member 2b, etc., in a liquid-tight manner.

Cover unit 20g has a circular shape having a diameter substantially equal to that of the inner circumference of the housing main unit 20e. Cover unit 20g comprises an aperture portion 20k for injecting and discharging the insulating oil 9.

Cover unit 20h has a circular shape having a diameter substantially equal to that of the inner circumference of the housing main unit 20e. A ventilation hole 20m through which air as atmosphere passes is formed in cover unit 20h.

C-shaped snap ring 20j is a fixing member which retains the state in which cover unit 20h is pressed onto the peripheral portion (sealing portion) of rubber member 2b.

Rubber member 2b is a rubber bellows (rubber film). Rubber member 2b is circular. The peripheral portion (sealing portion) of rubber member 2b has an O-ring shape. Rubber member 2b is provided between the housing main unit 20e and cover units 20g and 20h, and seals the space between them in a liquid-tight manner. Rubber member 2b is provided along the inner circumference of the end portion of the housing main unit 20e. Rubber member 2b is provided so as to separate a partial space inside the housing. In the present embodiment, rubber member 2b is provided in the space surrounded by cover units 20g and 20h, and separates this space into two in a liquid-tight manner. The space on the cover unit 20g side is referred to as a first space. The space on the cover unit 20h side is referred to as a second space. The first space communicates with the internal space of the housing main unit 20e filled with the insulating oil 9 via aperture portion 20k. Thus, the first space is filled with the insulating oil 9. The second space communicates with the external space via the ventilation hole 20m. Thus, the second space is air atmosphere.

An aperture portion 20o penetrates a part of the housing main unit 20e. An X-ray irradiation window 20w and X-ray shielding unit 540 are provided in aperture portion 20o. Aperture portion 20o is sealed by the X-ray irradiation window 20w and X-ray shielding unit 540 in a liquid-tight manner. As explained in detail later, X-ray shielding units 520 and 540 are provided to prevent X-ray irradiation to the outside of housing 20 in aperture portion 20o.

The X-ray irradiation window 20w is formed of a material which transmits X-rays. For example, the X-ray irradiation window 20w is formed of metal which transmits X-rays.

X-ray shielding units 510, 520, 530 and 540 should be formed of a material which does not transmit X-rays and contains at least lead. X-ray shielding units 510, 520, 530 and 540 may be formed of lead alloy, etc.

X-ray shielding unit 510 is provided on the inner surface of cover unit 20g. X-ray shielding unit 510 blocks the X-rays emitted from the X-ray tube 30. X-ray shielding unit 510 comprises a first shielding unit 511 and a second shielding unit 512. The first shielding unit 511 is attached to the inner surface of cover unit 20g. The first shielding unit 511 is provided so as to cover the entire inner surface of cover unit 20g. An end portion of the second shielding unit 512 is stacked on the inner surface of the first shielding unit 511. The other end portion of the second shielding unit 512 is provided inside the housing main unit 20e to be spaced apart from aperture portion 20k along the tube axis TA. The second shielding unit 512 is provided such that the insulating oil 9 passes through aperture portion 20k.

X-ray shielding unit 520 is substantially cylindrical. X-ray shielding unit 520 is provided in a part of the inner circumferential portion of the housing main unit 20e. An end portion of X-ray shielding unit 520 is close to the first shielding unit 511. Thus, it is possible to block X-rays which may be emitted from the space between X-ray shielding unit 510 and X-ray shielding unit 520. X-ray shielding unit 520 is cylindrical, and extends from the first shielding unit 511 to the vicinity of the stator coil 8 along the tube axis. In the present embodiment, X-ray shielding unit 520 extends from the first shielding unit 511 to a position just before the stator coil 8. X-ray shielding unit 520 is fixed to housing 20 depending on the need.

X-ray shielding unit 530 is cylindrical, and fits in the outer circumference of receptacle 302 described later inside housing 20. X-ray shielding unit 530 is provided such that an end portion of the cylinder is in contact with the wall surface of the housing main unit 20e. At this time, a hole for the passage of an end portion of X-ray shielding unit 530 is formed in X-ray shielding unit 520. X-ray shielding unit 530 is fixed to the outer circumference of receptacle 302 described later depending on the need.

X-ray shielding unit 540 is shaped like a frame, and is provided in a side edge of aperture portion 20o of housing 20. X-ray shielding unit 540 is provided along the internal wall of aperture portion 20o. An end portion of X-ray shielding unit 540 inside the housing main unit 20e is in contact with X-ray shielding unit 520. X-ray shielding unit 540 is fixed to the side edge of aperture portion 20o depending on the need.

Receptacle 301 for an anode and receptacle 302 for a cathode are connected to the housing main unit 20e. Each of receptacles 301 and 302 is shaped like a tube comprising a bottom and an aperture portion. The bottom portion of each of receptacles 301 and 302 is provided inside housing 20. Further, their aperture portions open to outside. For example, receptacles 301 and 302 are provided across an intervening gap in the housing main unit 20e. Further, their aperture portions face in the same direction.

A plug (not shown) inserted into receptacle 301 and receptacle 302 is of a non-surface-pressure type, and is detachably formed. In a state where the plug is connected to receptacle 301, high voltage (for example, +70 to +80 kV) is applied from the plug to a terminal 201.

Receptacle 301 is provided on the cover unit 20f side in housing 20. Further, receptacle 301 is provided on the internal side in comparison with cover unit 20f. Receptacle 301 comprises a housing 321 as an electric insulating member, and terminal 201 as a high-voltage supply terminal.

Housing 321 is formed of, for example, resin, as an insulating material. Housing 321 is shaped like a cylinder comprising a bottom in which a plug insertion hole opens to outside. Housing 321 comprises terminal 201 in the bottom portion. Housing 321 comprises an annular projection portion on the outer surface in the end portion on the aperture portion side. The projection portion of housing 321 is formed so as to fit in a step portion 20ea which is a step formed in an end portion of the projection portion of the housing main unit 20e. Terminal 201 is attached to the bottom portion of housing 321 in a liquid-tight manner, and penetrates the bottom portion. Terminal 201 is connected to a high-voltage supply terminal 44 as described later via an insulating covering line.

A rubber member 2f is provided between the projection portion of housing 321 and the housing main unit 20e. Rubber member 2f is provided between the projection portion of housing 321 and the step of step portion 20ea, and seals the space between the projection portion of housing 321 and the housing main unit 20e in a liquid-tight manner. In the present embodiment, rubber member 2f has an O-ring shape. Rubber member 2f prevents the insulting oil 9 from leaking out to the outside of housing 20. Rubber member 2f is rubber formed of, for example, sulfur vulcanization.

Housing 321 is fixed with a ring nut 311. A screw groove is formed in the outer circumferential portion of ring nut 311. For example, the outer circumferential portion of ring nut 311 is processed into a male screw. The inner circumferential portion of step portion 20ea is processed into a female screw. Thus, when ring nut 311 is mounted, the projection portion of housing 321 is pressed onto step portion 20ea via rubber member 2f. As a result, housing 321 is fixed to the housing main unit 20e.

Receptacle 302 is provided on the cover unit 20g side in housing 20. Further, receptacle 302 is provided on the internal side in comparison with cover unit 20g. Receptacle 302 is formed in the substantially same manner as receptacle 301.

Receptacle 302 comprises a housing 322 as an electric insulating member, and a terminal 202 as a high-voltage supply terminal.

Housing 322 is formed of, for example, resin, as an insulating material. Housing 322 is shaped like a cylinder comprising a bottom in which a plug insertion hole opens to outside. Housing 322 comprises terminal 202 in the bottom portion. Housing 322 comprises an annular projection portion on the outer surface in the end portion on the aperture portion side. The projection portion of housing 322 is formed so as to fit in a step portion 20eb which is a step formed in an end portion of the projection portion of the housing main unit 20e. Terminal 202 is attached to the bottom portion of housing 321 in a liquid-tight manner, and penetrates the bottom portion. Terminal 202 is connected to a high-voltage supply terminal 54 as described later via an insulating covering line.

A rubber member 2g is provided between the projection portion of housing 322 and the housing main unit 20e. Rubber member 2g is provided between the projection portion of housing 322 and the step of step portion 20eb, and seals the space between the projection portion of housing 321 and the housing main unit 20e in a liquid-tight manner. In the present embodiment, rubber member 2g has an O-ring shape. Rubber member 2g prevents the insulting oil 9 from leaking out to the outside of housing 20. Rubber member 2g is rubber formed of, for example, sulfur vulcanization.

Housing 322 is fixed with a ring nut 312. A screw groove is formed in the outer circumferential portion of ring nut 312. For example, the outer circumferential portion of ring nut 312 is processed into a male screw. The inner circumferential portion of step portion 20eb is processed into a female screw. Thus, when ring nut 312 is mounted, the projection portion of housing 322 is pressed onto step portion 20eb via rubber member 2g. As a result, housing 322 is fixed to the housing main unit 20e.

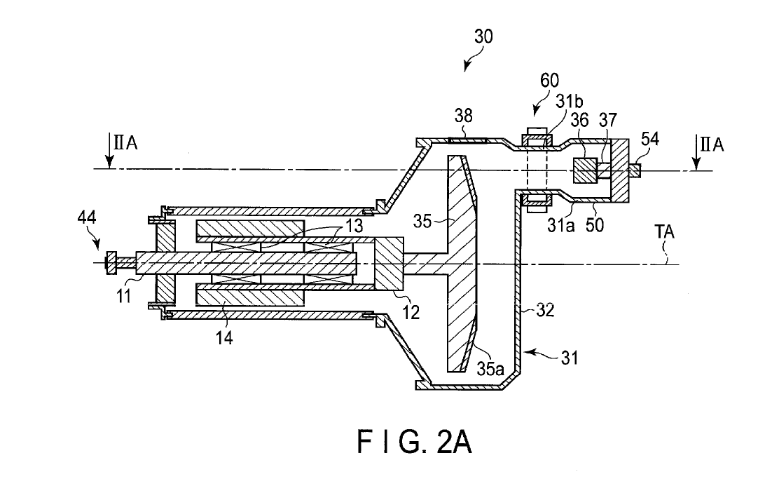

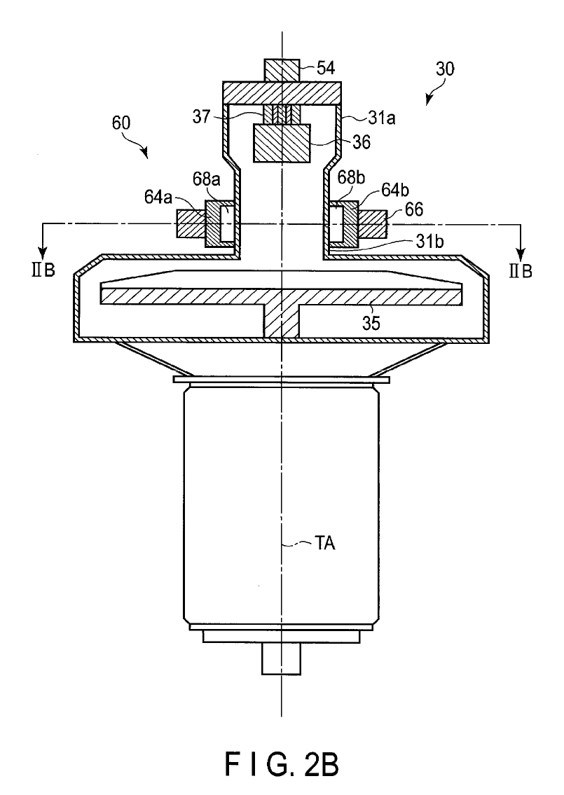

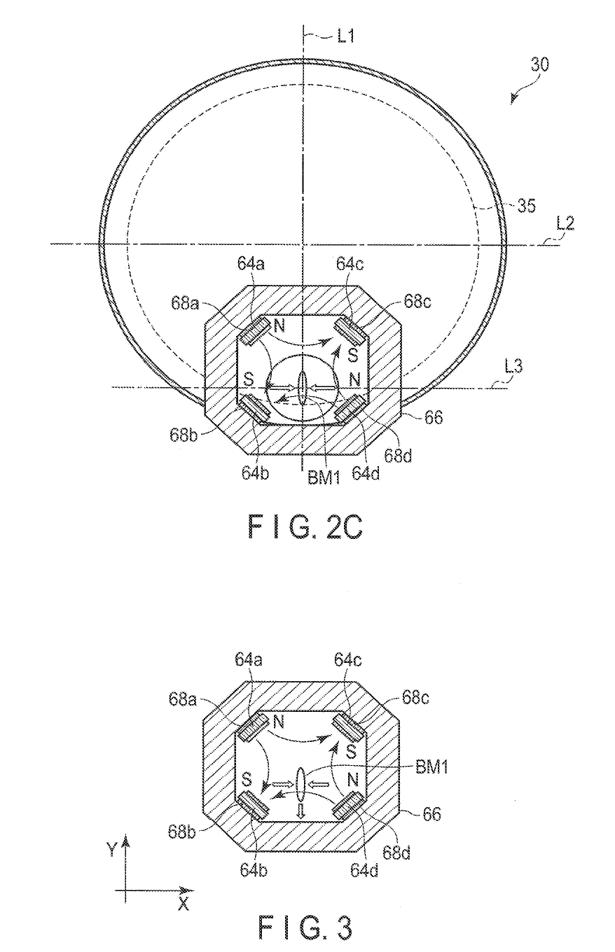

FIG. 2A is a cross-sectional view showing the general outline of the X-ray tube 30 according to the first embodiment. FIG. 2B is a cross-sectional view taken along line of FIG. 2A. FIG. 2C is a cross-sectional view taken along line IIB-IIB of FIG. 2B. In FIG. 2C, a straight line perpendicular to the tube axis TA is defined as straight line L1, and a straight line perpendicular to the tube axis TA and straight line L1 is defined as straight line L2.

The X-ray tube 30 comprises a fixed axis 11, a rotator 12, a bearing 13, a rotor 14, a vacuum envelope 31, a vacuum container 32, an anode target 35, a cathode 36, high-voltage supply terminal 44 and high-voltage supply terminal 54.

In FIG. 2C, a straight line which is perpendicular to a straight line parallel to the center of the cathode 36 or the emission direction of an electron beam and is parallel to straight line L2 is defined as straight line L3.

The fixed axis 11 is cylindrical. The fixed axis 11 rotatably supports the rotator 12 via the bearing 13. The fixed axis 11 comprises a projection portion attached to the vacuum envelope 31 in an air-tight manner at an end portion. The projection portion of the fixed axis 11 is fixed to a high-voltage insulating member 39. At this time, the end portion of the projection portion of the fixed axis 11 penetrates the high-voltage insulating member 39. High-voltage supply terminal 44 is electrically connected to the end portion of the projection portion of the fixed axis 11.

The rotator 12 is shaped like a tube comprising a bottom. The fixed axis 11 is inserted into the rotator 12. The rotator 12 is provided concentrically with the fixed axis 11. The rotator 12 is connected to the anode target 35 described later at the end portion on the bottom portion side, and is rotatably provided together with the anode target 35.

The bearing 13 is provided between the inner circumferential portion of the rotator and the outer circumferential portion of the fixed axis 11.

The rotor 14 is provided on the internal side of the cylindrical stator coil 8.

High-voltage supply terminal 44 applies relatively positive voltage to the anode target 35 via the fixed axis 11, the bearing 13 and the rotator 12. High-voltage supply terminal 44 is connected to receptacle 301. When a high-voltage supply source such as a plug (not shown) is connected to receptacle 301, current is supplied to receptacle 301. High-voltage supply terminal 44 is a metal terminal.

The anode target 35 is shaped like a disk. The anode target 35 is connected to the end portion of the rotator 12 on the bottom portion side concentrically with the rotator 12. For example, the central axis of the rotator 12 and the anode target 35 is provided along the tube axis TA. The axis of the rotator 12 and the anode target 35 is parallel to the tube axis TA. In this case, the rotator 12 and the anode target 35 are provided so as to be rotatable around the tube axis TA.

The anode target 35 comprises an umbrella target layer 35a provided in a part of the outer surface of the anode target. The target layer 35a emits X-rays in connection with the collision of the electrons emitted from the cathode 36. Blackening treatment is applied to the outer surface of the anode target 35 and the surface of the anode target 35 on a side opposite to the target layer 35a. The anode target 35 is formed of a nonmagnetic material having a high electric conductivity. For example, the anode target 35 is formed of copper, tungsten, molybdenum, niobium, tantalum or nonmagnetic stainless steel. The anode target 35 may have a structure in which at least the surface portion is formed of a nonmagnetic metal material having a high electric conductivity. Alternatively, the anode target 35 may have a structure in which the surface portion is covered with a covering member formed of a nonmagnetic metal material having a high electric conductivity.

Nonmagnetic materials having a high electric conductivity can more strongly twist magnetic lines generated by an AC magnetic field having an opposite direction based on eddy current than nonmagnetic materials having a low electric conductivity when they are provided in the AC magnetic field. Since the magnetic lines are twisted in this way, even when the quadrupole magnetic field generation unit 60 described later is close to the anode target 35 and generates an AC magnetic field, the magnetic lines flow along the surface of the anode target 35, and thus, the magnetic field (AC magnetic field) near the surface of the anode target 35 is strengthened.

The cathode 36 includes a filament (electron generation source) which emits electrons (electron beams). The cathode 36 is provided at a position facing the target layer 35a. The cathode 36 is a predetermined distance distant from the surface of the anode target 35. The cathode 36 emits electrons to the anode target 35. For example, the cathode 36 is cylindrical and emits electrons to the surface of the anode target 35 from the filament provided in the center of the circle. At this time, the straight line passing through the center of the cathode 36 is parallel to the tube axis TA. In the following description, the direction of the electrons emitted from the cathode 36 and their path may be referred to as an electron path. Relatively negative voltage is applied to the cathode 36. The cathode 36 is attached to a cathode supporting unit (cathode supporter or a cathode supporting member) 37 as described later, and is connected to high-voltage supply terminal 54 passing through the cathode supporting unit 37. It should be noted that the cathode 36 may be referred to as an electron generation source. In the cathode 36, the position for emitting electron beams coincides with the center. The center of the cathode 36 may include the straight line passing through the center in the following description.

The cathode supporting unit 37 comprises the cathode 36 in an end portion. The other end portion of the cathode supporting unit 37 is connected to the internal wall of the vacuum envelop 31 (vacuum container 32). The cathode supporting unit 37 internally comprises high-voltage supply terminal 54. As shown in FIG. 2A, the cathode supporting unit 37 extends from the internal wall of the vacuum envelop 31 (vacuum container 32) so as to reach the surface of the cathode 36 toward the anode target 35. For example, the cathode supporting unit 37 is cylindrical, and is provided concentrically with the cathode 36. At this time, an end surface of the cathode supporting unit 37 is connected to the surface of the vacuum envelop 31 (vacuum container 32). The other end surface of the cathode supporting unit 37 is connected to the surface of the cathode 36.

The cathode 36 comprises a nonmagnetic cover covering the entire outer circumference. The nonmagnetic cover is cylindrical so as to surround the circumference of the cathode 36. The nonmagnetic cover is formed of, for example, one of copper, tungsten, molybdenum, niobium, tantalum and nonmagnetic stainless steel, or is a nonmagnetic metal member formed of a metal material containing one of these elements as the main component. The nonmagnetic cover is preferably formed of a material having a high electric conductivity. Nonmagnetic covers having a high electric conductivity can more strongly twist magnetic lines generated by an AC magnetic field having an opposite direction based on eddy current than nonmagnetic covers having a low electric conductivity when they are provided in the AC magnetic field. Since the magnetic lines are twisted in this way, even when the quadrupole magnetic field generation unit 60 described later is close to the cathode 36 and generates an AC magnetic field, the magnetic lines flow along the circumference of the cathode 36, and thus, the magnetic field (AC magnetic field) near the surface of the cathode 36 is strengthened. The cathode 36 may be structured such that at least the surface portion is formed of a nonmagnetic metal material having a high electric conductivity.

An end portion of high-voltage supply terminal 54 is connected to the cathode 36 by passing through the cathode supporting unit 37. The other end portion of high-voltage supply terminal 54 is connected to receptacle 302. When a high-voltage supply source such as a plug (not shown) is connected to receptacle 302, high-voltage supply terminal 54 supplies current to the cathode 36. High-voltage supply terminal 54 is a metal terminal. High-voltage supply terminal 54 applies relatively negative voltage to the cathode 36 and supplies filament current to the filament (electron emission source; not shown) of the cathode 36.

The vacuum envelope 31 is sealed in vacuum atmosphere (in a vacuum-tight manner) and internally accommodates the fixed axis 11, the rotator 12, the bearing 13, the rotor 14, the vacuum container 32, the anode target 35, the cathode 36 and high-voltage supply terminal 54.

The vacuum container 32 comprises an X-ray transmissive window 38 in a vacuum-tight manner. The X-ray transmissive window 38 is provided in the wall portion of the vacuum envelope 31 (vacuum container 32) so as to face the target surface of the anode target 35 between the cathode 36 and the anode target 35. The X-ray transmissive window 38 is formed of, for example, metal, such as beryllium, titanium, stainless steel or aluminum, and is provided in a portion facing the X-ray irradiation window 20w. For example, the vacuum container 32 is sealed by the X-ray transmissive window 38 formed of beryllium as a member which transmits X-rays in an air-tight manner.

In the vacuum envelope 31, the high-voltage insulating member 39 is provided from the high-voltage supply terminal 44 side to the circumference of the anode target 35. The high-voltage insulating member 39 is formed of electric insulating resin.

The vacuum envelope 31 (vacuum container 32) comprises an accommodation unit 31a for installing the cathode 36. The accommodation unit 31a comprises a small radial portion 31b having a less radius in a portion between the anode target 35 and the cathode 36. For example, the accommodation unit 31a is cylindrical. The accommodation unit 31a is a part of the vacuum envelope 31, and extends from the vicinity of the X-ray transmissive window 38 toward the outside of the X-ray tube 30 along a straight line parallel to the tube axis TA. The accommodation unit 31a is provided so as to face the surface of the anode target 35. For example, as shown in FIG. 2A, the accommodation unit 31a faces the surface of the end portion of the anode target 35 in the radial direction, and extends from the vicinity of the X-ray transmissive window 38 along a straight line parallel to the tube axis TA.

The small radial portion 31b is provided to strengthen the effect of the magnetic field for the electron beams emitted from the cathode 36 when the quadrupole magnetic field generation unit 60 described later is installed. The small radial portion 31b is formed so as to have a radius less than that of the accommodation unit 31a around the small radial portion 31b. As shown in FIG. 2A and FIG. 2B, the small radial portion 31b is formed so as to have a radius less than that of the accommodation unit 31a around the small radial portion 31b between the anode target 35 and the cathode 36.

The vacuum envelope 31 collects the recoil electrons reflected on the anode target 35. Thus, the temperature of the vacuum envelope 31 is easily increased by the effect of the collision of recoil electrons. Normally, the vacuum envelope 31 is formed of a material having a high thermal conductivity such as copper. When the vacuum envelope 31 is influenced by an AC magnetic field, the vacuum envelope 31 is preferably formed of a material which does not generate a diamagnetic field. For example, the vacuum envelope 31 is formed of a nonmagnetic metal material. The vacuum envelope 31 is preferably formed of a nonmagnetic material having a high electric resistance such that overcurrent is not generated by alternating current. The nonmagnetic material having a high electric resistance is, for example, nonmagnetic stainless steel, Inconel, Inconel X, titanium, conductive ceramics or nonconductive ceramics coated with a metal thin film.

The high-voltage insulating member 39 has an annular shape such that an end is conical and the other end is closed. The high-voltage insulating member 39 is directly fixed to housing 20 or indirectly fixed to housing 20 via the stator coil 8 described later, etc.

The high-voltage insulating member 39 electrically disconnects the fixed axis 11 from either housing 20 or the stator coil 8. Thus, the high-voltage insulating member 39 is provided between the stator coil 8 and the fixed axis 11. The high-voltage insulating member 39 is provided so as to internally accommodate the X-ray tube 30 (vacuum container 32) on the projection portion side of the fixed axis 11 of the X-ray tube 30.

Returning to FIG. 1, the stator coil 8 is fixed to housing 20 at a plurality of positions. The stator coil 8 is provided around the outer circumferential portions of the rotor 14 and the high-voltage insulating member 39. The stator coil 8 rotates the rotor 14, the rotator 12 and the anode target 35. When a predetermined current is supplied to the stator coil 8, the magnetic field applied to the rotor 14 is generated. Thus, the anode target 35, etc., is rotated at a predetermined speed. When current is supplied to the stator coil 8 which is a rotation device, the rotor 14 rotates. In line with the rotation of the rotor 14, the anode target 35 rotates.

Inside housing 20, the insulating oil 9 fills the space surrounded by rubber bellows 2b, the housing main unit 20e, cover unit 20f and receptacles 301 and 302. The insulating oil 9 absorbs at least part of the heat generated by the X-ray tube 30.

Returning to FIG. 2A to FIG. 2C, the quadrupole magnetic field generation unit 60 is explained.

As shown in FIG. 2B and FIG. 2C, the quadrupole magnetic field generation unit 60 comprises coils 64 (64a, 64b, 64c and 64d), a yoke 66 and magnetic poles 68 (68a, 68b, 68c and 68d).

The quadrupole magnetic field generation unit 60 generates a magnetic field when an electric source supplies current to the quadrupole magnetic field generation unit 60. The quadrupole magnetic field generation unit 60 is capable of changing, for example, the strength (the density of magnetic flux) or direction of the magnetic field to be generated based on the strength or direction of the supply current.

The quadrupole magnetic field generation unit 60 comprises a quadrupole in which four magnetic poles are arranged close to each other such that adjacent magnetic poles have opposite polarities. When two adjacent magnetic poles are regarded as a dipole, and the other two magnetic poles are regarded as the other dipole, the directions of the magnetic fields generated by the two dipoles are opposite to each other. Thus, the quadrupole magnetic field generation unit 60 has an influence on the shape of the electron beams, such as the width or height, depending on the magnetic field to be generated. Neither the width nor the height of electron beams relates to the spatial arrangement of the X-ray tube 30. Each of the width and the height is a length in a direction perpendicular to a straight line accordance with the emission direction of electron beams. The width and the height are lengths in directions perpendicular to each other. In the quadrupole magnetic field generation unit 60 of the present embodiment, four magnetic poles 68 are provided in the form of a square. As described in detail later, in the quadrupole magnetic field generation unit 60, magnetic poles 68a, 68b, 68c and 68d face each other inside the yoke 66. For example, as shown in FIG. 2C, in the quadrupole magnetic field generation unit 60, magnetic pole 68a faces magnetic pole 68d, and magnetic pole 68b faces magnetic pole 68c.

The quadrupole magnetic field generation unit 60 is provided around the small radial portion 31b in the inner circumferential portion of the yoke 66 described later. The quadrupole magnetic field generation unit 60 is eccentrically provided such that its center does not overlap the central axis of the cathode 36. In other words, the quadrupole magnetic field generation unit 60 is provided such that the central position is off (in other words, eccentric with respect to) the central axis of the cathode 36. At this time, the center of the quadrupole magnetic field generation unit 60 substantially coincides with the center of the yoke 66 having a hollow circular or polygonal shape as described later. For example, as shown in FIG. 2C, the quadrupole magnetic field generation unit 60 is provided at a position moved from the central position of the cathode 36 in the radial direction (or along straight line L1) toward the central position of the anode target 35. Alternatively, the quadrupole magnetic field generation unit 60 may be provided so as to be off (in other words, eccentric) in a direction perpendicular to the path of electron beams (electron path) in a manner different from that of the above description.

When an electric source (not shown) for the quadrupole magnetic field generation unit 60 supplies current to coils 64, coils 64 generate a magnetic field. For example, each coil 64 is an electromagnetic coil. In the present embodiment, direct current is supplied from an electric source (not shown) to coils 64. Coils 64 include a plurality of coils 64a, 64b, 64c and 64d. Coils 64a to 64d are wound onto a part of magnetic poles 68a, 68b, 68c and 68d described later, respectively.

The yoke 66 has a hollow polygonal shape or a hollow cylindrical shape. The yoke 66 is formed of a soft magnetic material which has a high electric resistance and is difficult to generate eddy current by an AC magnetic field. For example, the yoke 66 is formed as a stacked element in which a thin plate formed of Fe—Si alloy (silicon steel), Fe—Al alloy, electromagnetic stainless steel, Fe—Ni high-permeability alloy such as permalloy, Ni—Cr alloy, Fe—Ni—Cr alloy, Fe—Ni—Co alloy or Fe—Cr alloy is interposed between electric insulating films, or as aggregate prepared by covering line members formed of the above materials with electric insulating films, bundling the line members and solidifying the bundle. Alternatively, the yoke 66 may be formed as a compact prepared by grinding the above materials into fine particles of approximately 1 μm, covering the surfaces with an electric insulating film and compressing them. Alternatively, the yoke 66 may be formed of soft ferrite, etc.

Magnetic poles 68 include a plurality of magnetic poles 68a, 68b, 68c and 68d. Magnetic poles 68a, 68b 68c and 68d are provided in the inner circumferential wall of the yoke 66. Magnetic poles 68a to 68d are provided so as to surround the electron path of electron beams around the small radial portion 31b. In the quadrupole magnetic field generation unit 60, magnetic poles 68a to 68d are evenly provided in the rotational direction of the anode target 35 at positions in a direction perpendicular to the emission direction of electrons emitted from the filament included in the cathode 36. For example, as shown in FIG. 2C, magnetic poles 68a to 68d are provided at the positions of the vertexes of the square. Magnetic poles 68a to 68d are preferably provided so as to be close to the emission direction (electron path) of electrons emitted from the filament included in the cathode 36 to increase the density of magnetic flux.

Magnetic poles 68a to 68d have substantially the same shape. Magnetic poles 68a to 68d include two dipoles each corresponding to a pair of magnetic poles. For example, magnetic pole 68a and magnetic pole 68b are a dipole (a pair of magnetic poles 68a and 68b). Magnetic pole 68c and magnetic pole 68d are a dipole (a pair of magnetic poles 68c and 68d). When direct current is supplied to magnetic poles 68 via respective coils 64 (64a, 64b, 64c and 64d), a pair of magnetic poles 68a and 68b forms a DC magnetic field having a direction opposite to that of a pair of magnetic poles 68c and 68d. Magnetic poles 68a to 68d are provided such that the surface (end surface) faces the electron path of the electron beams emitted from the cathode 36 to change the shape of the electron beams emitted from the cathode 36 to increase the density of magnetic flux.

The principle of the quadrupole magnetic field generation unit 60 of the present embodiment is explained below with reference to the accompanying drawings. FIG. 3 shows the principle of the quadrupole magnetic field generation unit of the present embodiment. In FIG. 3, an X-direction and a Y-direction are directions perpendicular to the direction in which electron beams are emitted, and are perpendicular to each other. The X-direction is a direction from the magnetic pole 68b (magnetic pole 68a) side to the magnetic pole 68d (magnetic pole 68c) side. The Y-direction is a direction from the magnetic pole 68d (magnetic pole 68b) side to the magnetic pole 68c (magnetic pole 68a) side.

In FIG. 3, it is assumed that an electron beam BM1 travels from the front side to the far side of the figure. It is assumed that the electron beam BM1 is roundly emitted. In FIG. 3, magnetic pole 68a generates a north-pole magnetic field. Magnetic pole 68b generates a south-pole magnetic field. Magnetic pole 68c generates a south-pole magnetic field. Magnetic pole 68d generates a north-pole magnetic field. In this case, a magnetic field from magnetic pole 68c to magnetic poles 68a and 68d and a magnetic field from magnetic pole 68b to magnetic poles 68a and 68d are formed. When the electron beam BM1 passes through substantially the center of the space surrounded by magnetic poles 68a to 68d, the shape of the electron beam BM1 is changed in directions facing each other in the X-direction by the Lorentz force of the generated magnetic field, and is changed to directions moving away from each other in the Y-direction. In the present embodiment, the quadrupole magnetic field generation unit 60 is provided such that the center is eccentric with respect to the central position of the cathode 36 in the radial direction of the anode target 35 (or the Y-direction). Thus, the electron beam BM1 is strongly influenced by the Lorentz force in the directions facing each other in the X-direction and the Lorentz force going in one of the directions in the Y-direction. For example, as shown in FIG. 3, the electron beam BM1 is strongly influenced by the Lorentz force in the directions facing each other in the X-direction and the Lorentz force going in a direction opposite to the direction going to the center of the anode target 35 in the Y-direction (the radial direction of the anode target 35). In the quadrupole magnetic field generation unit 60, when the position for the electron beam emitted from the cathode 36 is changed, the strength of the effect of the magnetic field having an influence on the electron beam is changed. As a result, as shown in FIG. 3, in the electron beam BM1, the width in the X-direction is reduced. However, the length in the Y-direction does not substantially change, and deviates to a direction opposite to the direction going to the center of the anode target 35 in the Y-direction (or the radial direction of the anode target 35).

In the present embodiment, when the X-ray tube device 1 is driven, electrons are emitted from the filament included in the cathode 36 to the focal spot on the anode target 35 with which the electrons collide. Here, the direction in which electrons are emitted (electron path) is assumed to be parallel to the straight line passing through the center of the cathode 36. In the quadrupole magnetic field generation unit 60, an electric source (not shown) supplies direct current to each coil 64 (coils 64a to 64d). When direct current is supplied from the electric source, the quadrupole magnetic field generation unit 60 generates a magnetic field between magnetic poles 68a to 68d as a quadruple. The electron beam emitted from the cathode 36 collides with the anode target 35 so as to cross the magnetic field generated between the cathode 36 and the anode target 35. At this time, the shape of the electron beam is formed (focused) by the magnetic field generated by the quadrupole magnetic field generation unit 60. In the present embodiment, the quadrupole magnetic field generation unit 60 is provided such that the central position deviates (is eccentric) in the radial direction of the anode target 35. Thus, the quadrupole magnetic field generation unit 60 is capable of reducing the width of the beam and deflecting the electron beam to the radial direction of the anode target 35 in a manner different from a case where the quadrupole magnetic field generation unit 60 is provided concentrically with the central axis of the cathode 36. For example, as shown in FIG. 3, the quadrupole magnetic field generation unit 60 is capable of changing the shape of the electron beam roundly emitted to an elliptical shape (in other words, focusing the electron beam into an elliptical shape) by shrinking the electron beam in the X-direction. Further, the quadrupole magnetic field generation unit 60 is capable of deflecting the electron beam in a direction opposite to the direction going to the center of the anode target 35 in the Y-direction (the radial direction of the anode target 35). In this case, the quadrupole magnetic field generation unit 60 is capable of reducing the size of the apparent focal spot of the electron beam and increasing the size of the actual focal spot of collision on the anode target 35 surface. As a result, thermal load for the anode target 35 is reduced.

In the present embodiment, the X-ray tube device 1 comprises the X-ray tube 30, and the quadrupole magnetic field generation unit 60 which generates a magnetic field forming an electron beam. The quadrupole magnetic field generation unit 60 generates a magnetic field between magnetic poles 68a to 68d when direct current is supplied from an electric source to each coil 64. The quadrupole magnetic field generation unit 60 is capable of changing the shape of and deflecting the electron beam emitted from the cathode 36 by the magnetic field generated by magnetic poles 68a to 68d. At this time, the quadrupole magnetic field generation unit 60 is provided such that the central position is moved from the position of the path of an electron beam in accordance with the desired shape of the beam and the desired direction of deflection. In this way, the X-ray tube device 1 of the present embodiment is capable of magnetically changing the shape of an electron beam to an optimal shape based on the intended purpose.

Now, this specification explains an X-ray tube device according to another embodiment. In the embodiment, the same structural elements as those of the first embodiment are denoted by like reference numbers, detailed description thereof being omitted.

### Second Embodiment

According to a second embodiment, an X-ray tube device 1 comprises coils for deflecting an electron beam in addition to the structures of the first embodiment.

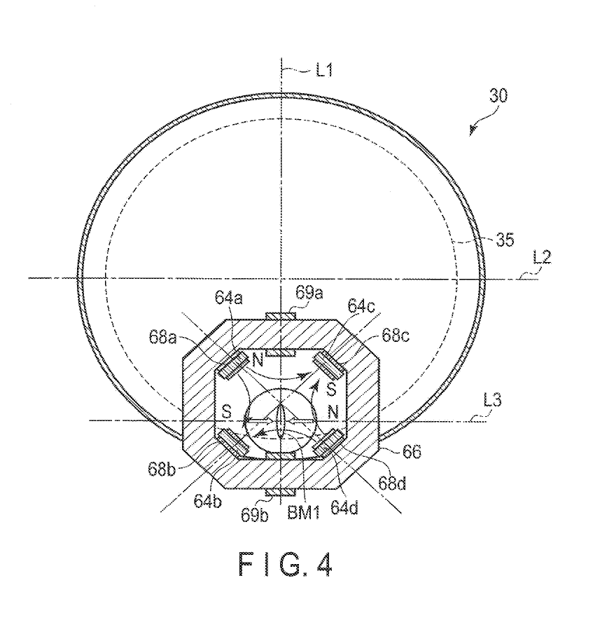

FIG. 4 shows the general outline of the X-ray tube device according to the second embodiment.

As shown in FIG. 4, in the second embodiment, a quadrupole magnetic field generation unit 60 further comprises deflection coil units 69a and 69b.

The quadrupole magnetic field generation unit 60 generates dipole DC magnetic fields by superimposition such that the magnetic fields generated from two pairs of magnetic poles have the same direction. The quadrupole magnetic field generation unit 60 comprises a pair of magnetic poles 68a and 68c, and a pair of magnetic poles 68b and 68d. A pair of magnetic poles 68a and 68c and a pair of magnetic poles 68b and 68d each form a magnetic field as a dipole. The quadrupole magnetic field generation unit 60 forms a magnetic field by superimposing a DC magnetic field on the DC magnetic field generated between a pair of magnetic poles 68a and 89c and a pair of magnetic poles 68b and 68d when current is supplied to each of deflection coils 69a and 69b described later.

In the quadrupole magnetic field generation unit 60, the direct current supplied from an electric source (not shown) to deflection coil units 69a and 69b described later is controlled by a deflection electric source controller (not shown). The quadrupole magnetic field generation unit 60 is capable of changing the shape of and deflecting an electron beam having the desired direction when the quadrupole magnetic field generation unit 60 is provided such that the center is eccentric in a direction perpendicular to the electron path. For example, as shown in FIG. 4, the quadrupole magnetic field generation unit 60 is capable of reducing the width of the electron beam emitted from a cathode 36 and correcting the movement in the radial direction caused by the change in the width by deflection. The quadrupole magnetic field generation unit 60 is capable of adjusting the position of the focal spot on the surface of an anode target 35 with which the electron beam collides and reducing the thermal load on the focal spot.

Deflection coil units 69a and 69b (a first deflection coil unit and a second deflection coil unit) are electromagnetic coils which generate a magnetic field based on the current supplied from an electric source (not shown). In the present embodiment, when direct current is supplied from an electric source (not shown) to each of deflection coil units 69a and 69b, deflection coil units 69a and 69b generate a DC magnetic field. Defection coil units 69a and 69b are capable of deflecting the path of an electron beam to a predetermined direction by changing the ratio of the current to be supplied. Each of deflection coil units 69a and 69b is wound onto a portion between adjacent ones of magnetic poles 68a to 68d connected to a yoke 66. As shown in FIG. 4, deflection coil unit 69a is wound onto the main unit of the yoke 66 between magnetic poles 68a and 68c. Deflection coil unit 69b is wound onto the main unit of the yoke 66 between magnetic poles 68b and 68d. In this case, a pair of magnetic poles 68a and 68c generates a DC magnetic field between them. A pair of magnetic poles 68b and 68d generates a DC magnetic field between them.

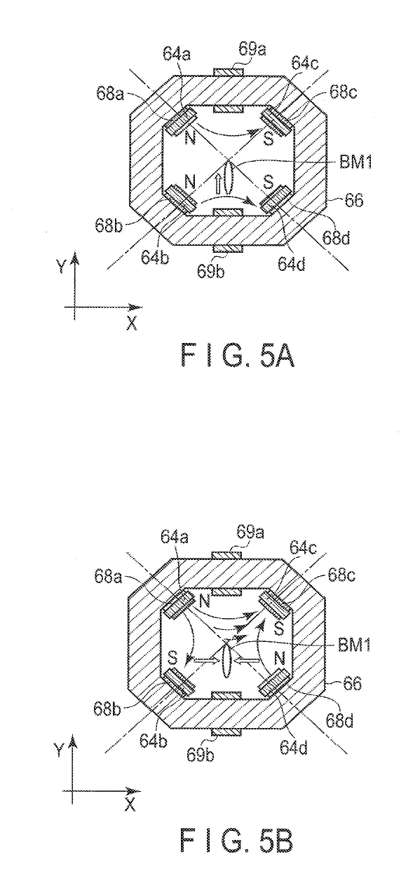

This specification explains the principle of the quadrupole magnetic field generation unit 60 of the present embodiment with reference to the accompanying drawings. FIG. 5A shows the principle of a dipole magnetic field according to the second embodiment. FIG. 5B shows the principle of the quadrupole magnetic field generation unit 60 according to the second embodiment. In FIG. 5A and FIG. 5B, an X-direction and a Y-direction are directions perpendicular to the direction in which an electron beam is emitted, and are perpendicular to each other. The X-direction is a direction from the magnetic pole 68a (magnetic pole 68b) side to the magnetic pole 68c (magnetic pole 68d) side. The Y-direction is a direction from the magnetic pole 68d (magnetic pole 68b) side to the magnetic pole 68c (magnetic pole 68a) side.

In FIG. 5A and FIG. 5B, it is assumed that an electron beam BM1 travels from the front side to the far side of the figure. In FIG. 5A and FIG. 5B, a pair of magnetic poles 68a and 68c is a dipole (a pair of magnetic poles). A pair of magnetic poles 68b and 68d is a dipole (a pair of magnetic poles). A pair of magnetic poles 68a and 68c generates a DC magnetic field going in a direction accordance with the X-direction. A pair of magnetic poles 68b and 68d generates a DC magnetic field accordance with the X-direction. When the quadrupole magnetic field generation unit 60 is not influenced by deflection coil unit 69a or 69b, the quadrupole magnetic field generation unit 60 generates the magnetic field shown in FIG. 3 of the first embodiment.

As shown in FIG. 5A, it is assumed that deflection coil unit 69a generates a north-pole magnetic field in magnetic pole 68a and generates a south-pole magnetic field in magnetic pole 68c. Similarly, deflection coil unit 69b generates a north-pole magnetic field in magnetic pole 68b and generates a south-pole magnetic field in magnetic pole 68d. Thus, a magnetic field from magnetic pole 68a to magnetic pole 68c and a magnetic field from magnetic pole 68b to magnetic pole 68d are formed by deflection coils 69a and 69b, respectively.

In the quadrupole magnetic field generation unit 60, because of the effect of the magnetic fields of deflection coil units 69a and 69b shown in FIG. 5A, the magnetic field generated in deflection coil unit 69a is superimposed on the magnetic field from magnetic pole 68a to magnetic pole 68c. Further, the magnetic field generated in deflection coil unit 69b is superimposed on the magnetic field from magnetic pole 68d to magnetic pole 68b. Thus, as shown in FIG. 5B, the quadrupole magnetic field generation unit 60 generates a superimposed magnetic field from magnetic pole 68c to magnetic pole 68a in addition to the magnetic field of the quadrupole. Here, the magnetic fields between magnetic pole 68b and magnetic pole 68d are cancelled by each other.

In the present embodiment, when the X-ray tube device 1 is driven, electrons are emitted from the filament included in the cathode 36 to the focal spot of the electrons on the anode target 35. The direction in which the electrons are emitted is assumed to be parallel to the straight line passing through the center of the cathode 36. In the quadrupole magnetic field generation unit 60, direct current is supplied from an electric source (not shown) to deflection coil units 69a and 69b. For example, when direct current is supplied from the electric source, the quadrupole magnetic field generation unit 60 forms a magnetic field by superimposing the magnetic fields generated in deflection coil units 69a and 69b on the magnetic fields of the quadrupole between a pair of magnetic poles 68a and 68c as a dipole and a pair of magnetic poles 68b and 68d as a dipole. In this way, for example, as shown in FIG. 5B, when the quadrupole magnetic field generation unit 60 deviates from (is eccentric with respect to) the electron path in a perpendicular direction, the quadrupole magnetic field generation unit 60 is capable of performing correction by deflecting the movement (deflection or eccentricity) in the length direction (Y-direction) caused when the electron beam is changed in the width direction (X-direction) by the magnetic fields of the quadrupole to the opposite direction.

In the present embodiment, the X-ray tube device 1 comprises the quadrupole magnetic field generation unit 60 comprising deflection coil units 69a and 69b. The quadrupole magnetic field generation unit 60 is capable of generating a superimposed deflection magnetic field when direct current is supplied from an electric source to deflection coil units 69a and 69b. In the first embodiment, the quadrupole magnetic field generation unit 60 deviates (is eccentric) in a direction perpendicular to the path of the electron beam, and thus, the electron beam is deflected in a single direction. However, in the present embodiment, the quadrupole magnetic field generation unit 60 is capable of performing correction by deflecting the movement (deflection or eccentricity) in the length direction (Y-direction) caused when the shape of the electron beam is changed in the width direction (X-direction) to the opposite direction. Thus, the X-ray tube device 1 of the present embodiment is capable of magnetically changing the shape of an electron beam to an optimal shape in accordance with the intended use.

In the present embodiment, in the quadrupole magnetic field generation unit 60, direct current is supplied from an electric source to deflection coil units 69a and 69b. However, alternating current may be supplied.

In this case, the quadrupole magnetic field generation unit 60 generates dipole AC magnetic fields such that the magnetic fields generated from two pairs of magnetic poles have the same direction. For example, the quadrupole magnetic field generation unit 60 comprises a pair of magnetic poles 68a and 68c and a pair of magnetic poles 68b and 68d. A pair of magnetic poles 68a and 68c and a pair of magnetic poles 68b and 68d each form a magnetic field as a dipole. A pair of magnetic poles 68a and 68c and a pair of magnetic poles 68b and 68d each form an AC magnetic field between them.

The quadrupole magnetic field generation unit 60 is capable of intermittently or continuously deflecting the path of electrons by the AC magnetic field generated between dipoles when alternating current is supplied. In the quadrupole magnetic generation unit 60, the alternating current supplied from an electric source (not shown) to deflection coil units 69a and 69b described later is controlled by a deflection electric source controller (not shown) such that the focal spot of collision with the electron beam emitted from the cathode 36 is intermittently or continuously moved. The quadrupole magnetic field generation unit 60 is capable of deflecting the electron beam emitted from the cathode 36 to a direction parallel to the radial direction of the anode target 35. The quadrupole magnetic field generation unit 60 is capable of moving the position of the focal spot on the surface of the anode target 35 with which an electron beam collides.

Now, this specification explains some modification examples of the present embodiment below with reference to the accompanying drawings. Each X-ray tube device 1 of the modification examples has structures similar to those of the X-ray tube device 1 of the second embodiment. The same structural elements as those of the X-ray tube device 1 of the second embodiment are denoted by like reference numbers, detailed description thereof being omitted.

### Modification Example 1

In the X-ray tube device 1 of modification example 1 of the second embodiment, each deflection coil is provided at a position rotated by 90° around the cathode 36 in comparison with deflection coils 69a and 69b of the second embodiment.

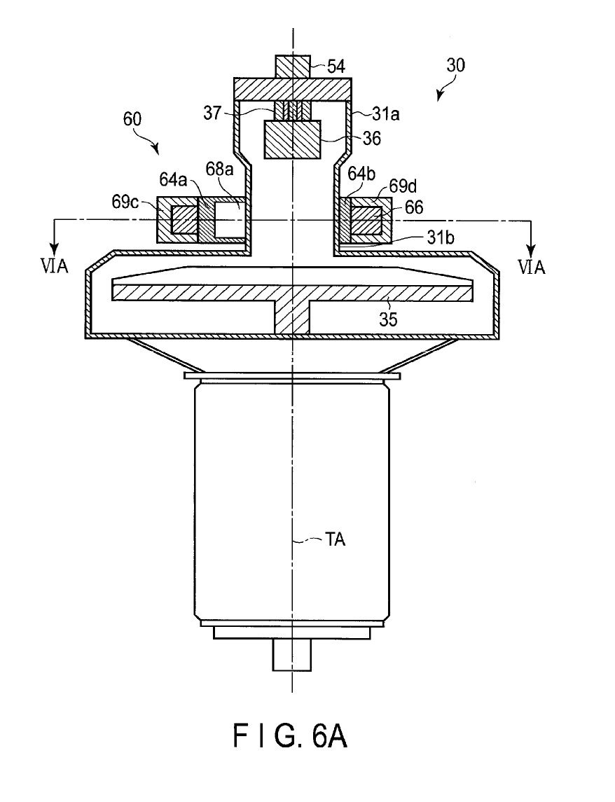

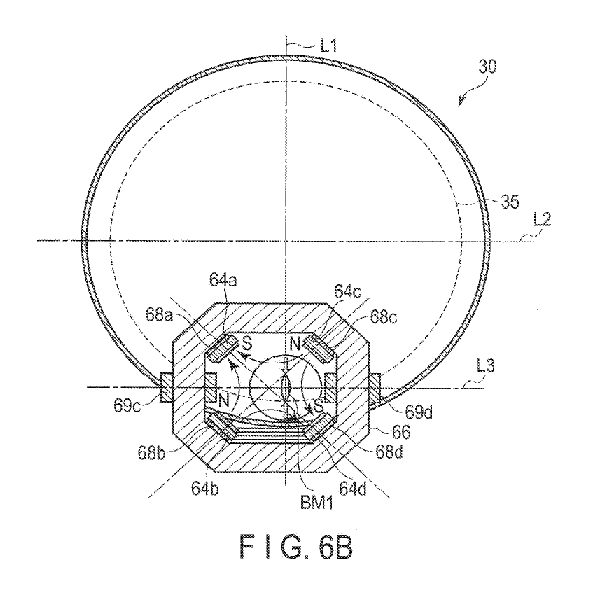

FIG. 6A is a cross-sectional view showing the general outline of an X-ray tube 30 according to modification example 1 of the second embodiment. FIG. 6B is a cross-sectional view taken along line VIA-VIA of FIG. 6A.

As shown in FIG. 6A and FIG. 6B, the quadrupole magnetic field generation unit 60 of modification example 1 of the present embodiment further comprises deflection coil units 69c and 69d. As shown in FIG. 6B, for example, the quadrupole magnetic field generation unit 60 of modification example 1 is eccentrically provided with respect to the central axis of the cathode 36 in accordance with the direction of straight line L3.

When an electric source (not shown) supplies current to deflection coil units 69c and 69d (a third deflection coil unit and a fourth deflection coil unit), deflection coil units 69c and 69d generate a magnetic field. In the present embodiment, when direct current is supplied from an electric source (not shown) to each of deflection coil units 69c and 69d, deflection coil units 69c and 68d generate a DC magnetic field. Deflection coil units 69c and 69d are capable of deflecting the path of an electron beam to a predetermined direction based on the supplied current. Each of deflection coil units 69c and 69d is wound onto a portion between adjacent ones of magnetic poles 68a to 68d connected to the yoke 66. As shown in FIG. 6B, deflection coil unit 69c is wound onto the main unit of the yoke 66 between magnetic poles 68a and 68b. Deflection coil unit 69d is wound onto the main unit of the yoke 66 between magnetic pole units 68c and 68d. In this case, for example, a pair of magnetic poles 68a and 68b generates a DC magnetic field between them. A pair of magnetic poles 68c and 68d generates a DC magnetic field between them.

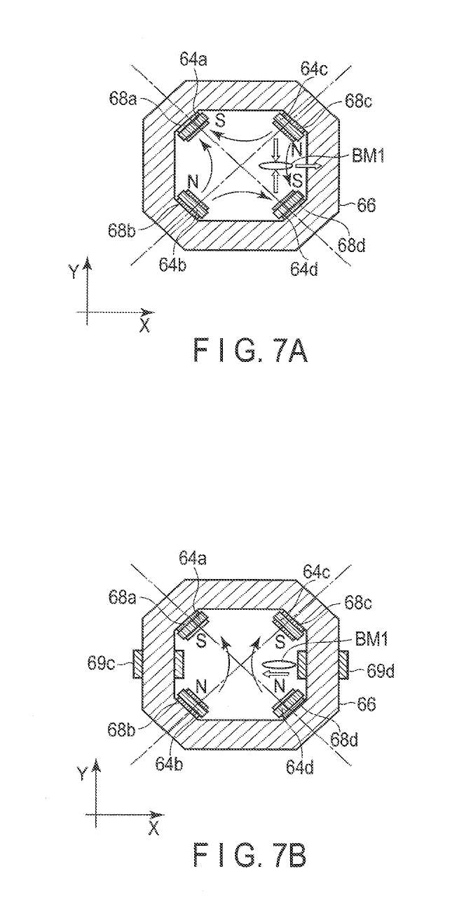

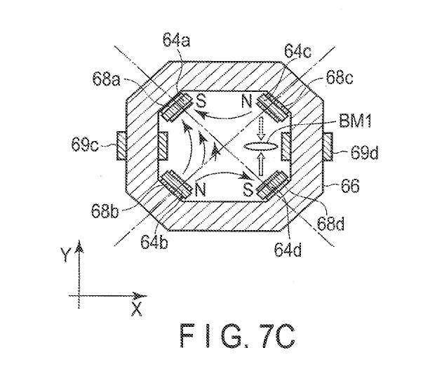

Now, this specification explains the principle of the quadrupole magnetic field generation unit 60 of the present embodiment with reference to the accompanying drawings. FIG. 7A is a cross-sectional view showing the principle of a quadrupole magnetic field according to modification example 1 of the second embodiment. FIG. 7B is a cross-sectional view showing the principle of a dipole magnetic field according to modification example 1 of the second embodiment. FIG. 7C is a cross-sectional view showing the principle of the quadrupole magnetic field generation unit according to modification example 1 of the second embodiment. In FIG. 7A to FIG. 7C, the X-direction and the Y-direction are directions perpendicular to the direction in which an electron beam is emitted, and are perpendicular to each other. The X-direction is a direction from the magnetic pole 68b (magnetic pole 68a) side to the magnetic pole 68d (magnetic pole 68c) side. The Y-direction is a direction from the magnetic pole 68b (magnetic pole 68d) side to the magnetic pole 68a (magnetic pole 68c) side.

In FIG. 7A to FIG. 7C, it is assumed that the electron beam BM1 travels from the front side to the far side of the drawings. In FIG. 7A to FIG. 7C, a pair of magnetic poles 68a and 68b is a dipole (a pair of magnetic poles). A pair of magnetic poles 68c and 68d is a dipole (a pair of magnetic poles). A pair of magnetic poles 68a and 68b generates a DC magnetic field going in a direction accordance with the Y-direction. A pair of magnetic poles 68c and 68d generates a DC magnetic field accordance with the Y-direction.

As shown in FIG. 7A, in modification example 1, when the quadrupole magnetic field generation unit 60 is not influenced by deflection coil unit 69c or 69d, the quadrupole magnetic field generation unit 60 generates the magnetic field shown in FIG. 3 of the first embodiment.

As shown in FIG. 7B, deflection coil unit 69c generates a south-pole magnetic field in magnetic pole 68a and generates a north-pole magnetic field in magnetic pole 68b. Similarly, deflection coil unit 69d generates a south-pole magnetic field in magnetic pole 68c and generates a north-pole magnetic field in magnetic pole 68d. Thus, a magnetic field from magnetic pole 68b to magnetic pole 68a and a magnetic field from magnetic pole 68d to magnetic pole 68c are formed by deflection coil units 69c and 69d, respectively.

In the quadrupole magnetic field generation unit 60, because of the effect of the magnetic fields of deflection coil units 69c and 69d shown in FIG. 7B, the magnetic field generated in deflection coil unit 69c is superimposed on the magnetic field having a direction from magnetic pole 68b to magnetic pole 68a. Further, the magnetic field generated in deflection coil unit 69d is superimposed on the magnetic field having a direction from magnetic pole 68c to magnetic pole 68d. As shown in FIG. 5B, the quadrupole magnetic field generation unit 60 generates a superimposed magnetic field from magnetic pole 68a to magnetic pole 68b in addition to the magnetic fields of the quadrupole shown in FIG. 7A. Here, the magnetic fields between magnetic pole 68c and magnetic pole 68d are cancelled by each other.

In the present embodiment, when the X-ray tube device 1 is driven, electrons are emitted from the filament included in the cathode 36 to the focal spot of the electrons on the anode target 35. It is assumed that the direction in which electrons are emitted is parallel to the straight line passing through the center of the cathode 36. In the quadrupole magnetic field generation unit 60, direct current is supplied from an electric source (not shown) to deflection coil units 69c and 69d. For example, when direct current is supplied from the electric source, the quadrupole magnetic field generation unit 60 forms a magnetic field by superimposing the magnetic fields generated in deflection coil units 69c and 69d on the magnetic fields of the quadrupole between a pair of magnetic poles 68a and 68b as a dipole and a pair of magnetic poles 68c and 68d as a dipole. Thus, for example, as shown in FIG. 7C, when the quadrupole magnetic field generation unit 60 deviates from (is eccentric with respect to) the electron path in a perpendicular direction, the quadrupole magnetic field generation unit 60 is capable of performing correction by deflecting the movement (deflection or eccentricity) in the width direction (Y-direction) caused when the shape of the electron beam is changed in the length direction (Y-direction) by the magnetic fields of the quadrupole to the opposite direction.

In the present embodiment, the X-ray tube device 1 comprises the quadrupole magnetic field generation unit 60 comprising deflection coil units 69c and 69d. The quadrupole magnetic field generation unit 60 is capable of generating a superimposed magnetic field when direct current is supplied from an electric source to deflection coil units 69c and 69d. In the first embodiment, the quadrupole magnetic field generation unit 60 deviates from (is eccentric with respect to) the path of an electron beam in a perpendicular direction, and thus, the electron beam is deflected in a single direction. However, in the present embodiment, the quadrupole magnetic field generation unit 60 is capable of performing correction by deflecting the movement (deflection or eccentricity) in the width direction (Y-direction) caused when the shape of the electron beam is changed in the length direction (Y-direction) to the opposite direction. Thus, the X-ray tube device 1 of the present embodiment is capable of magnetically changing the shape of an electron beam to an optimal shape in accordance with the intended purpose.

In modification example 1 of the present embodiment, direct current is supplied from an electric source to deflection coil units 69c and 69d of the quadrupole magnetic field generation unit 60. However, alternating current may be supplied.

In this case, the quadrupole magnetic field generation unit 60 generates dipole AC magnetic fields such that the magnetic fields generated from two pairs of magnetic poles have the same direction. For example, the quadrupole magnetic field generation unit 60 comprises a pair of magnetic poles 68a and 68b, and a pair of magnetic poles 68c and 68d. A pair of magnetic poles 68a and 68b and a pair of magnetic poles 68c and 68d each form a magnetic field as a dipole. A pair of magnetic poles 68a and 68b and a pair of magnetic poles 68c and 68d each form an AC magnetic field between them.

The quadrupole magnetic field generation unit 60 is capable of intermittently or continuously deflecting the path of electrons by the AC magnetic fields generated between dipoles when alternating current is supplied. In the quadrupole magnetic generation unit 60, the alternating current supplied from an electric source (not shown) to deflection coil units 69c and 69d described later is controlled by a deflection electric source controller (not shown) such that the focal spot of collision with the electron beam emitted from the cathode 36 is intermittently or continuously moved. The quadrupole magnetic field generation unit 60 is capable of deflecting the electron beam emitted from the cathode 36 to a direction parallel to the radial direction of the anode target 35. The quadrupole magnetic field generation unit 60 is capable of moving the position of the focal spot on the surface of the anode target 35 with which an electron beam collides.

### Modification Example 2

The X-ray tube device 1 of modification example 2 of the second embodiment comprises the quadrupole magnetic field generation unit 60 comprising the above deflection coil units 69a and 69b, and a quadrupole magnetic field generation unit comprising deflection coil units 69c and 69d.

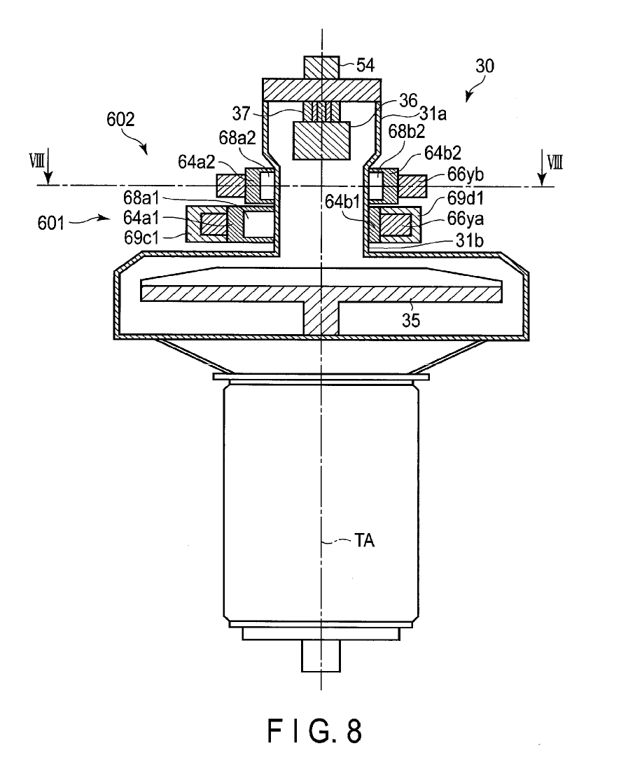

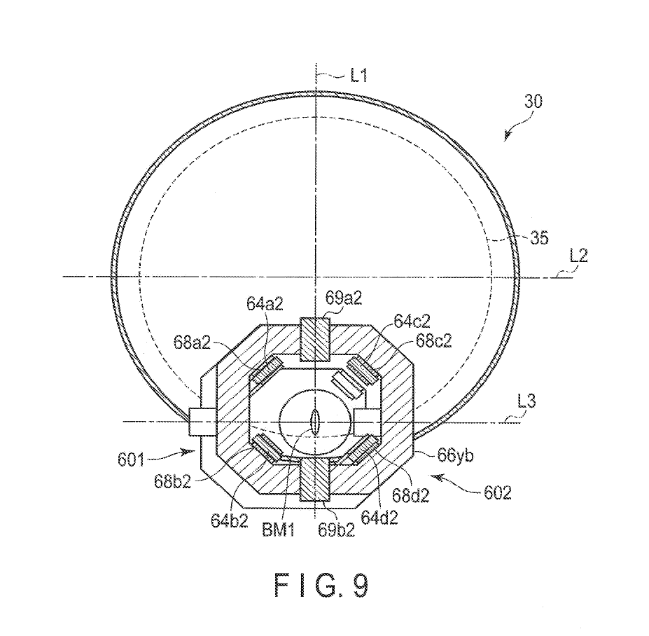

FIG. 8 is a cross-sectional view showing the general outline of the X-ray tube 30 according to modification example 2 of the second embodiment. FIG. 9 is a cross-sectional view taken along line VIII-VIII of FIG. 8.

As shown in FIG. 8, the X-ray tube 30 of modification example 2 of the present embodiment comprises two quadrupole magnetic field generation units 601 and 602. Quadrupole magnetic field generation units 601 and 602 are provided in a small radial portion 31b. Quadrupole magnetic field generation units 601 and 602 are arranged in the small radial portion 31b. Quadrupole magnetic field generation unit 601 is provided on the anode target 35 side in the small radial portion 31b. Quadrupole magnetic field generation unit 602 is provided on the cathode 36 side in the small radial portion 31b in comparison with quadrupole magnetic field generation unit 601.

Quadrupole magnetic field generation units 601 and 602 deviate from (are eccentric with respect to) the electron path of the electron beam emitted from the cathode 36 in a perpendicular direction. For example, as shown in FIG. 9, quadrupole magnetic field generation unit 601 is provided so as to deviate (be eccentric) in a direction parallel to straight line L3 in a manner similar to that of modification example 1 of the second embodiment. Quadrupole magnetic field generation unit 602 is eccentrically provided in a direction parallel to straight line L1 (the radial direction of the anode target 35) in a manner similar to that of the second embodiment.

Quadrupole magnetic field generation unit 601 has a structure similar to that of quadrupole magnetic field generation unit 60 of modification example 1 of the second embodiment. Thus, detailed description of the same structural elements is omitted. Quadrupole magnetic field generation unit 601 comprises coils 64 (64a1, 64b1, 64c1 and 64d1), a yoke 66ya and magnetic poles 68 (68a1, 68b1, 68c1 and 68d1).

Coils 64 (64a1, 64b1, 64c1 and 64d1) are similar to coils 64 (61a, 64b, 64c and 64d) of modification example 1 of the second embodiment, respectively.

Yoke 66ya is similar to yoke 66 of modification example 1 of the second embodiment.

Magnetic poles 68 (68a1, 68b1, 68c1 and 68d1) are similar to magnetic poles 68 (68a, 68b, 68c and 68d) of modification example 1 of the second embodiment, respectively.

Quadrupole magnetic field generation unit 602 has a structure similar to that of quadrupole magnetic field generation unit 60 of the second embodiment. Quadrupole magnetic field generation unit 602 comprises coils 64 (64a2, 64b2, 64c2 and 64d2), a yoke 66yb, and magnetic poles 68 (68a2, 68b2, 68c2 and 68d2).

Coils 64 (64a2, 64b2, 64c2 and 64d2) are similar to coils 64 (64a, 64b, 64c and 64d) of the second embodiment, respectively.

Yoke 66yb is similar to yoke 66 of the second embodiment.

Magnetic poles 68 (68a2, 68b2, 68c2 and 68d2) are similar to magnetic poles 68 (68a, 68b, 68c and 68d) of the second embodiment, respectively.

In the present embodiment, the X-ray tube device 1 comprises quadrupole magnetic field generation unit 601 comprising deflection coil units 69a and 69d, and quadrupole magnetic field generation unit 602 comprising deflection coil units 69c and 69d. Quadrupole magnetic field generation units 601 and 602 are each capable of generating a superimposed magnetic field when direct current is supplied from an electric source to deflection coil units 69a and 69d and deflection coil units 69c and 69d. Thus, the X-ray tube device 1 of the present embodiment is capable of magnetically changing the shape of an electron beam into an optimal shape in accordance with the intended purpose.

Now, this specification explains an X-ray tube device according to a third embodiment. In the third embodiment, the same structural elements as those of the above embodiments are denoted by like reference numbers, detailed description thereof being omitted.

### Third Embodiment

According to the third embodiment, an X-ray tube device 10 does not comprise an accommodation unit 31a. Thus, an anode target 35 is close to a cathode 36. In this respect, the third embodiment is different from the above embodiments. The X-ray tube device 10 of the third embodiment is different from those of the above embodiments in terms of the structures of a vacuum envelope 31 (vacuum container 32), a quadrupole magnetic field generation unit, etc.

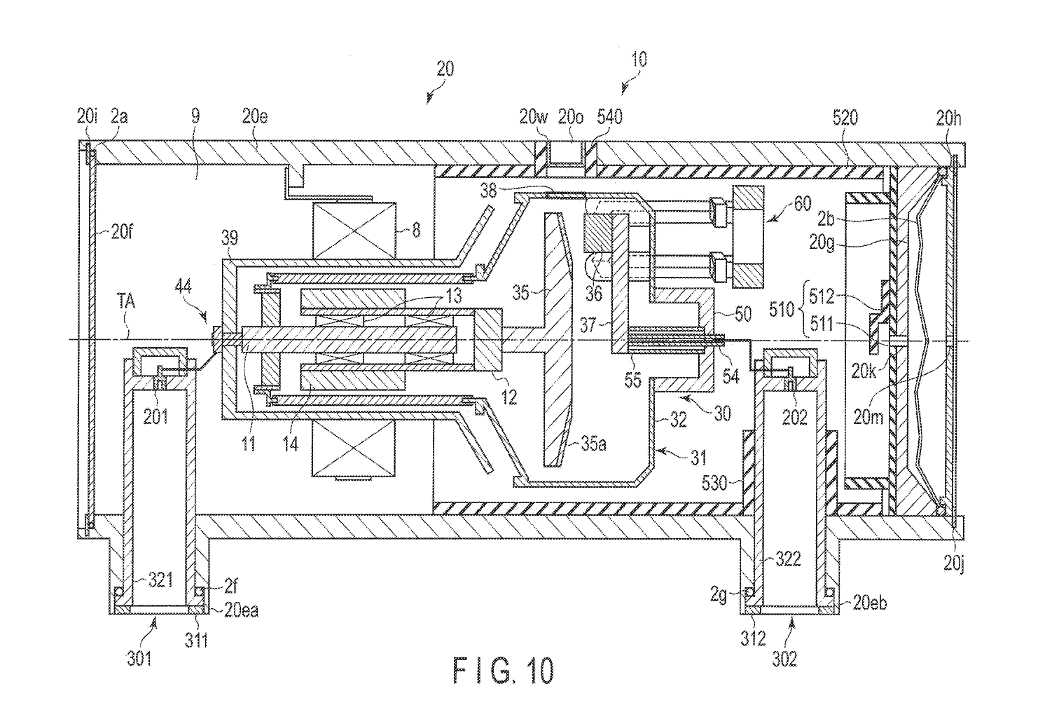

FIG. 10 is a cross-sectional view showing an example of the X-ray tube device according to the third embodiment.

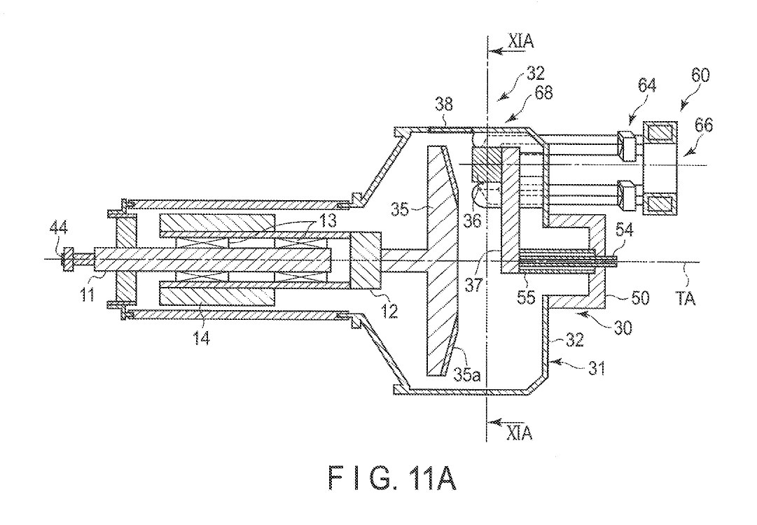

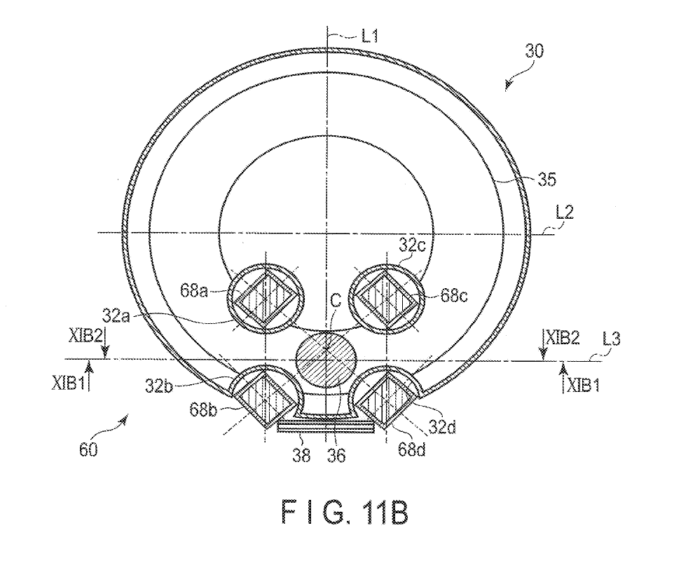

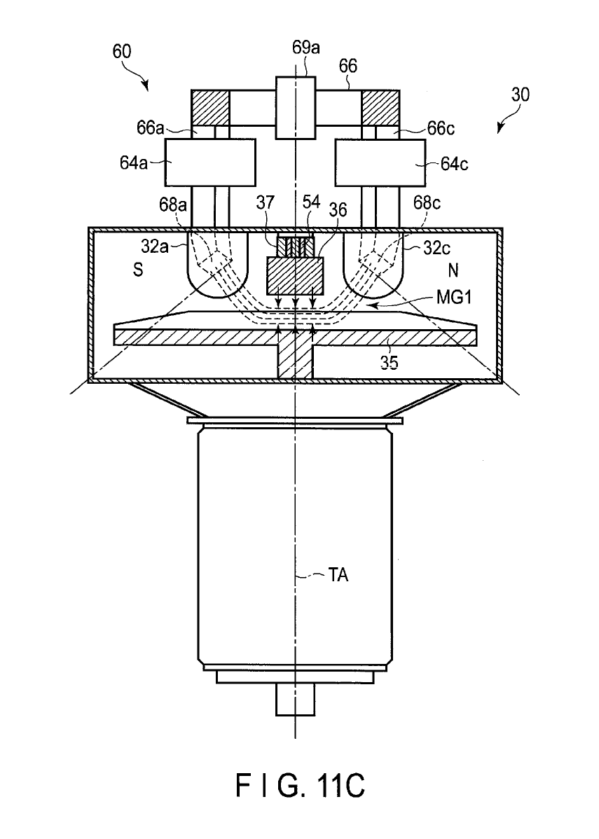

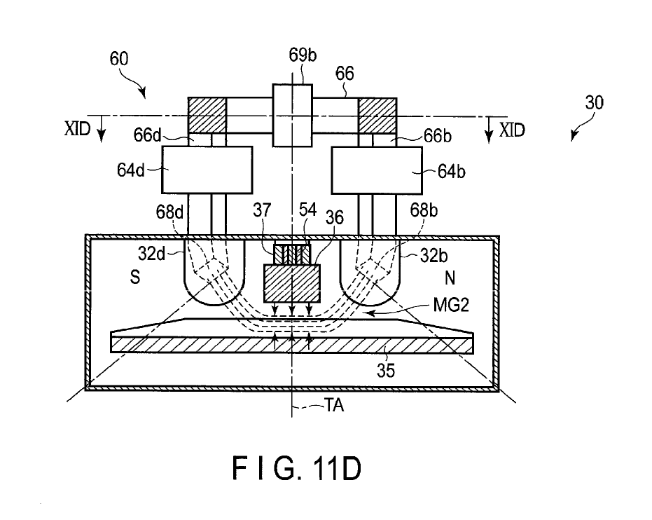

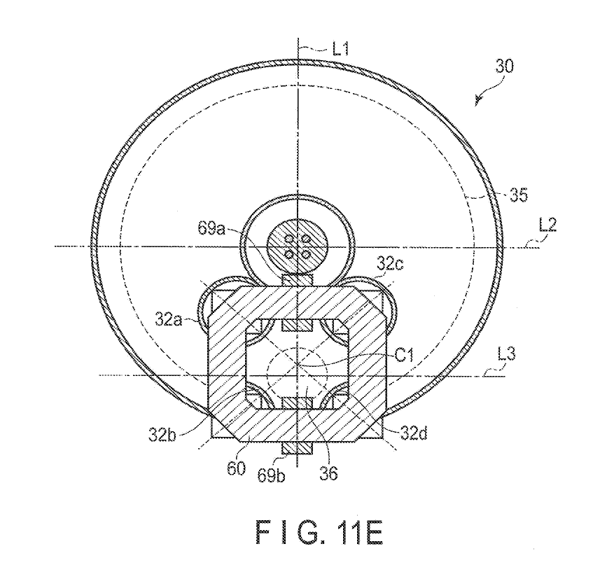

FIG. 11A is a cross-sectional view showing the general outline of an X-ray tube 30 according to the third embodiment. FIG. 11B is a cross-sectional view taken along line XIA-XIA of FIG. 11A. FIG. 11C is a cross-sectional view taken along line XIB1-XIB1 of FIG. 11B. FIG. 11D is a cross-sectional view taken along line XIB2-XIB2 of FIG. 11B. FIG. 113 is a cross-sectional view taken along line XID-XID of FIG. 11D.

In FIG. 11B and FIG. 11E, a straight line perpendicular to a tube axis TA is defined as straight line L1. A straight line perpendicular to the tube axis TA and straight line L1 is defined as straight line L2. In FIG. 11B and FIG. 11E, a straight line which is perpendicular to a straight line parallel to the center of the cathode 36 or the emission direction of an electron beam and is parallel to straight line L2 is defined as straight line L3.

In addition to the structures of the above embodiments, the X-ray tube 30 comprises a KOV member 55.

The anode target 35 is formed of a nonmagnetic material having a high electric conductivity. For example, the anode target 35 is formed of copper, tungsten, molybdenum, niobium, tantalum, nonmagnetic stainless steel, etc. The anode target 35 may be structured such that at least the surface portion is formed of a nonmagnetic metal material having a high electric conductivity. Alternatively, the anode target 35 may be structured such that the surface portion is covered with a covering member formed of a nonmagnetic metal material having a high conductivity.

The cathode 36 is attached to a cathode supporting unit (a cathode supporter or a cathode supporting member) 37 as described later, and is connected to a high-voltage supply terminal 54 passing through the cathode supporting unit 37. The cathode 36 may be referred to as an electron generation source. In the cathode 36, the emission position of an electron beam coincides with the center. The center of the cathode 36 may include the straight line passing through the center in the following description.

The cathode supporting unit 37 comprises the cathode 36 in an end portion, and comprises the KOV member 55 in the other end portion. The cathode supporting unit 37 internally comprises high-voltage supply terminal 54. As shown in FIG. 11A, the cathode supporting unit 37 is provided so as to extend from the KOV member 55 provided around the tube axis TA to the vicinity of the outer circumference of the anode target 35. The cathode supporting unit 37 is provided substantially parallel to the anode target 35 across an intervening predetermined gap. At this time, the cathode supporting unit 37 comprises the cathode 36 in the end portion on the outer circumferential side of the anode target 35.

The KOV member 55 is formed of low-expansion alloy. An end portion of the KOV member 55 is attached to the cathode supporting unit 37 by brazing. The other end portion of the KOV member 55 is attached to a high-voltage insulating member 50 by brazing. The KOV member 55 covers high-voltage supply terminal 54 inside the vacuum envelope 31 described later.

High-voltage supply terminal 54 is attached to high-voltage insulating member 50 by brazing. High-voltage supply terminal 54 and the KOV member 55 penetrate the vacuum container 32 described later and are inserted into the vacuum envelope 31. At this time, the insertion portion of high-voltage supply terminal 54 is sealed in a vacuum-tight manner and is inserted into the vacuum envelope 31.

High-voltage supply terminal 54 passes through the cathode supporting unit 37 and is connected to the cathode 36. High-voltage supply terminal 54 applies relatively negative voltage to the cathode 36 and supplies filament current to the filament (electron emission source; not shown) of the cathode 36. High-voltage supply terminal 54 is connected to a receptacle 302. When a high-voltage supply source (not shown) such as a plug is connected to the receptacle 302, current is supplied to high-voltage supply terminal 54. High-voltage supply terminal 54 is a metal terminal.

The vacuum envelope 31 is sealed in vacuum atmosphere (in a vacuum-tight manner), and internally accommodates a fixed axis 11, a rotator 12, a bearing 13, a rotor 14, the vacuum container 32, the anode target 35, the cathode 36, high-voltage supply terminal 54 and the KOV member 55.

The vacuum container 32 comprises an X-ray transmissive window 38 in a vacuum-tight manner. The X-ray transmissive window 38 is provided in the wall portion of the vacuum envelope 31 (vacuum container 32) facing the area between the cathode 36 and the anode target 35. The X-ray transmissive window 38 is formed of, for example, metal such as beryllium, titanium, stainless steel or aluminum, and is provided in a portion of the vacuum container 32 facing the X-ray emission window 20w. For example, the vacuum container 32 is sealed in an air-tight manner by the X-ray transmissive window 38 formed of beryllium as a member which transmits X-rays. In the vacuum envelope 31, a high-voltage insulating member 39 is provide from the high-voltage supply terminal 44 side to the vicinity of the anode target 35. High-voltage insulating member 39 is formed of electric-insulating resin.

The vacuum envelope 31 (vacuum container 32) comprises concave portions for accommodating the end portion of a quadrupole magnetic generation unit 60 as described later. As shown in FIG. 11B, in the present embodiment, the vacuum envelope 31 (vacuum container 32) comprises a plurality of concave portions 32a, 32b, 32c and 32d. Each of concave portions and 32d is formed in a part of the vacuum envelope 31 (vacuum container 32). Each of concave portions 32a, 32b, 32c and 32d is a part of the vacuum envelope 31 (vacuum container 32) surrounding the concave portion. For example, concave portions 32a to 32d are formed by hollowing the vacuum envelope 31 (vacuum container 32) from outside so as to surround the cathode 36 in a direction perpendicular to the direction in which an electron beam is emitted. When observed from the internal side of the vacuum envelope 31 (vacuum container 32), concave portions 32a to 32d are formed so as to project parallelly to the emission direction of the electron beam of the cathode 36.

Concave portions 32a to 32d are evenly arranged around the central axis from a predetermined central position (the center of the concave portions). For example, concave portions 32a to 32d are arranged at equal angle intervals based on a position (the center of the concave portions) deviating in a perpendicular direction from the electron path around the cathode 36. In this case, concave portion 32b is formed at a position by 90° in a rotational direction (in a counterclockwise direction) with respect to concave portion 32a around the center of the concave portions. Similarly, concave portion 32d is formed at a position by 90° in the rotational direction with respect to concave portion 32b around the center of the cathode 36. Concave portion 32c is formed at a position by 90° in the rotational direction with respect to concave portion 32d around the center of the cathode 36.

For example, as shown in FIG. 115, concave portion 32a is provided at the position of 45° from straight line L1 in the rotational direction around the center of the concave portions. Concave portion 32b is set at the position rotated by 90° from concave portion 32a the rotational direction around the center of the cathode 36. Concave portion 32d is provided at the position rotated by 90° from concave portion 32b in the rotational direction around the center of the cathode 36. Concave portion 32c is provided at the position rotated by 90° from concave portion 32d in the rotational direction around the center of the cathode 36. Thus, concave portions 32a to 32d are provided at the positions of the vertexes of a square.

Concave portions 32a to 32d are formed such that they are not extremely close to the surface of the anode target 35 or the surface of the cathode 36 to prevent discharge, etc. For example, concave portion 32a is hollowed to a position more distant from the surface of the anode target 35 than the surface of the cathode 36 facing the surface of the anode target 35 in a direction parallel to the tube axis TA. Alternatively, concave portion 32a may be hollowed to the same position as the surface of the cathode 36 or a position slightly closer to the surface of the anode target 35 than the surface of the cathode 36 in a direction parallel to the tube axis TA. In concave portions 32a to 32d, to separate them from the target surface of the anode target 35 and the surface of the cathode 36 for the prevention of discharge, etc., the corner portions projecting to the anode target 35 side are curved or inclined. For example, as shown in FIG. 11C, the corner portions of concave portions 32a to 32d are curved. The corner portions of concave portions 32a to 32d may be formed at inclined angles along the inclined angles of magnetic poles 68 (68a, 68b, 68c and 68d) described later, respectively. In concave portions 32a to 32d, the corner portions projecting to the anode target 35 side may not have an inclination or diameter.

The number of concave portions may not be four as long as they are provided so as to surround a part of the axis (electron path) parallel to the emission direction of the electron beam of the cathode 36. For example, concave portions 32a to 32d may be integrally formed. Alternatively, concave portions 32a and 32b may be integrally formed, and concave portions 32c and 32d may be integrally formed.

The vacuum envelope 31 collects the recoil electrons reflected on the anode target 35. Thus, the temperature of the vacuum envelope 31 is easily increased by the effect of the collision with the recoil electrons. Normally, the vacuum envelope 31 is formed of a material having a high thermal conductivity such as copper. When the vacuum envelope 31 is influenced by an AC magnetic field, the vacuum envelope 31 is preferably formed of a material which does not generate a diamagnetic field. For example, the vacuum envelope 31 is formed of a nonmagnetic metal material. The vacuum envelope 31 is preferably formed of a nonmagnetic material having a high electric resistance to prevent overcurrent by alternating current. The nonmagnetic material having a high electric resistance is, for example, nonmagnetic stainless steel, Inconel, Inconel X, titanium, conductive ceramics, nonconductive ceramics coated with a metal thin film. More preferably, in the vacuum envelope 31, concave portions 32a to 32d are formed of a nonmagnetic material having a high electric resistance, and the portions other than concave portions 32a to 32d are formed of a nonmagnetic material having a high thermal conductivity such as copper.

This specification explains the details of the quadrupole magnetic field generation unit 60 below with reference to FIG. 11B to FIG. 11E.

As shown in FIG. 11B and FIG. 11E, the quadrupole magnetic field generation unit 60 comprises coils 64 (64a, 64b, 64c and 64d), a yoke 66 (66a, 66b, 66c and 66d), magnetic poles 68 (68a, 68b, 68c and 68d), and deflection coil units 69a and 69b.

In the present embodiment, the quadrupole magnetic field generation unit 60 is provided such that the center is eccentric with respect to the electron path emitted from the cathode 36 in a perpendicular direction. For example, as shown in FIG. 11E, the four magnetic poles 68 of the quadrupole magnetic field generation unit 60 are provided in a square form. As described in detail later, the quadrupole magnetic field generation unit 60 comprises magnetic poles 68a, 68b, 68c and 68d at the ends of projection portions 66a, 66b, 66c and 66d projecting from the main unit of the yoke 66.

As schematically shown in FIG. 11C and FIG. 11D, a pair of magnetic poles 68a and 68c and a pair of magnetic poles 68b and 68d each form a magnetic field between them. In the quadrupole magnetic field generation unit 60, the direct current supplied from an electric source (not shown) to deflection coil units 69a and 69b described later is controlled by a deflection electric source controller (not shown). The quadrupole magnetic field generation unit 60 is capable of changing the shape of and deflecting the electron beam having a predetermined direction when the quadrupole magnetic field generation unit 60 is provided such that the center is eccentric with respect to the electron path in a perpendicular direction. For example, as shown in FIG. 4, the quadrupole magnetic field generation unit 60 is capable of reducing the width of the electron beam emitted from the cathode 36 and correcting the movement of the focal spot on the anode target 35 in the radial direction caused by the change in the width by deflection. The quadrupole magnetic field generation unit 60 is capable of adjusting the position of the focal spot on the surface of the anode target 35 with which an electron beam collides and reducing the thermal load on the focal spot.

When an electric source (not shown) for the quadrupole magnetic field generation unit 60 supplies current to coils 64, coils 64 generate a magnetic field. In the present embodiment, direct current is supplied from an electric source (not shown) to coils 64. Coils 64 include a plurality of coils 64a, 64b, 64c and 64d. Coils 64a to 64d are wound onto a part of projection portions 66a, 66b, 66c and 66d of the yoke 66 described later, respectively.

The yoke 66 comprises projection portions 66a, 66b, 66c and 66d projecting from the main unit. Projection portions 66a to 66d project in a direction parallel to the emission direction (electron path) of an electron beam. Projection portions 66a to 66d project in the same direction, and are parallel to each other. Projection portions 66a to 66d have the same length and shape. The main unit of the yoke 66 has a hollow polygonal shape or a hollow cylindrical shape. In the present embodiment, the yoke 66 is provided such that four projection portions 66a to 66d are accommodated in concave portions 32a to 32d, respectively. At this time, the yoke 66 is provided such that the cathode 36 is surrounded by four projection portions 66a to 66d. Coils 64 are wound onto a part of the respective four projection portions.

Specifically, coil 64a is wound onto a part of projection portion 66a of the yoke 66. The portion around which coil 64a does not wind is accommodated in concave portion 32a. Similarly, coils 64b, 64c and 64d are wound onto a part of respective projection portions 66b, 66c and 66d. The portions around which coil 64b, 64c or 64d does not wind are accommodated in concave portions 32b, 32c and 32d, respectively.

Magnetic poles 68 include a plurality of magnetic poles 68a, 68b, 68c and 68d. Magnetic poles 68a, 68b, 68c and 68d are provided in the end portions of projection portions 66a, 66b, 66c and 66d of the yoke 66, respectively. Magnetic poles 68a to 68d are provided so as to surround the cathode 36. In the quadrupole magnetic field generation unit 60, magnetic poles 68a to 68d are evenly provided around the center (the center of the magnetic poles) at the respective positions in a direction perpendicular to the emission direction of the electrons emitted from the filament included in the cathode 36. At this time, the position of the center of the arrangement of magnetic poles 68a to 68d (the center of the magnetic poles) is an intersection of the straight lines passing through the centers of magnetic poles 68a to 68d.

For example, in a manner similar to that of the above concave portions 32a to 32d, as shown in FIG. 11B, magnetic pole 68a is provided at the position of 45° from straight light L1 around the magnetic pole center C1 in the rotational direction (in a counterclockwise direction). Magnetic pole 68b is set at a position rotated by 90° from magnetic pole 68a around the magnetic pole center C1 in the rotational direction. Magnetic pole 68d is provided at a position rotated by 90° from magnetic pole 68b around the magnetic pole center C1 in the rotational direction. Magnetic pole 68c is provided at a position rotated by 90° from magnetic pole 68d around the magnetic pole center C1 in the rotational direction. Thus, magnetic poles 68a to 68d are provided at the positions of the vertexes of a square.

Magnetic poles 68a to 68d are preferably provided so as to be moderately close to the emission direction (electron path) of the electrons emitted from the filament included in the cathode 36 to increase the density of magnetic flux. Magnetic pole 68a is provided near the curved wall surface of concave portion 32a on the cathode 36 side. Similarly, magnetic poles 68b to 68d are provided near the curved wall surfaces of concave portions 32b to 32d on the cathode 36 side. Concave portions 32a to 32d are provided such that they are not excessively close to the cathode 36 to prevent discharge, etc.

Magnetic poles 68a to 68d have substantially the same shape. Magnetic poles 68a to 68d include two dipoles each including a pair of magnetic poles. For example, magnetic poles 68a and 68b are a dipole (a pair of magnetic poles 68a and 68b). Magnetic poles 68c and 68d are a dipole (a pair of magnetic poles 68c and 68d). When direct current is supplied to magnetic poles 68 via coils 64, a pair of magnetic poles 68a and 68b forms a DC magnetic field having a direction opposite to that of a pair of magnetic poles 68c and 68d. The surfaces (end surfaces) of magnetic poles 68a to 68d face the center of the magnetic poles to change the shape of the electron beam emitted from the cathode 36 in a state where the density of magnetic flux is increased as much as possible without being excessively close to the anode target 35. Magnetic poles 68a to 68d are formed such that their surfaces face each other.

For example, magnetic poles 68a to 68d have inclined surfaces at the same angle with respect to the straight line passing through the magnetic pole center C1 and parallel to the tube axis TA. The inclined angle from the straight line passing through the magnetic pole center C1 and parallel to the tube axis TA to the surface of magnetic pole 68a is defined as γ1. The inclined angle from the straight line passing through the magnetic pole center C1 and parallel to the tube axis TA to the surface of magnetic pole 68d is defined as γ4. The inclined angle from the straight line passing through the magnetic pole center C1 and parallel to the tube axis TA to the surface of magnetic pole 68b is defined as γ2. The inclined angle from the straight line passing through the magnetic pole center C1 and parallel to the tube axis TA to the surface of magnetic pole 68c is defined as γ3. Thus, for example, when magnetic poles 68a to 68d are provided at the same inclination, γ1=γ2=γ3=γ4. At this time, the inclination angles γ (γ1, γ2, γ3 and γ4) of magnetic poles 68a to 68d are set in the range of 0′<γ<90°. At this time, the inclined angles γ of magnetic poles 68a to 68d are set in the range of 0°<γ<90°. For example, when the inclined angles of magnetic poles 68a to 68d are the same as each other (γ1=γ2=γ3=γ4), inclinations γ1, γ2, γ3 and γ4 of pairs of magnetic poles 68a to 68d are formed in the range of 30°≦γ≦60°. Further, inclinations γ1, γ2, γ3 and γ4 of magnetic poles 68a to 68d may be formed so as to be 45° with respect to the straight line passing through the magnetic pole center C1 and parallel to the tube axis TA.

Deflection coil units 69a and 69b (a first deflection coil unit and a second deflection coil unit) are electromagnetic coils which generate a magnetic field when an electric source (not shown) supplies current to deflection coil units 69a and 69b. In the present embodiment, each of deflection coil units 69a and 69b generates a DC magnetic field when direct current is supplied from an electric source (not shown). Each of deflection coil units 69a and 69b is wound onto a portion between adjacent ones of projection portions 66a to 66d of the main unit of the yoke 66. As shown in FIG. 11C and FIG. 11D, deflection coil unit 69a is wound onto the main unit of the yoke 66 between projection portions 66a and 66c. Deflection coil unit 69b is wound onto the main unit of the yoke 66 between projection portions 66b and 66d. In this case, a pair of magnetic poles 68a and 68c generates a DC magnetic field between them. A pair of magnetic poles 68b and 68d generates a DC magnetic field between them.

Deflection coil units 69a and 69b generate a dipole magnetic field formed in a direction which is perpendicular to the radial direction of the anode target 35 and is parallel to the width direction of the filament included in the cathode 36. Deflection coil units 69a and 69b are capable of deflecting the path of an electron beam to a predetermined direction by the flowing current.

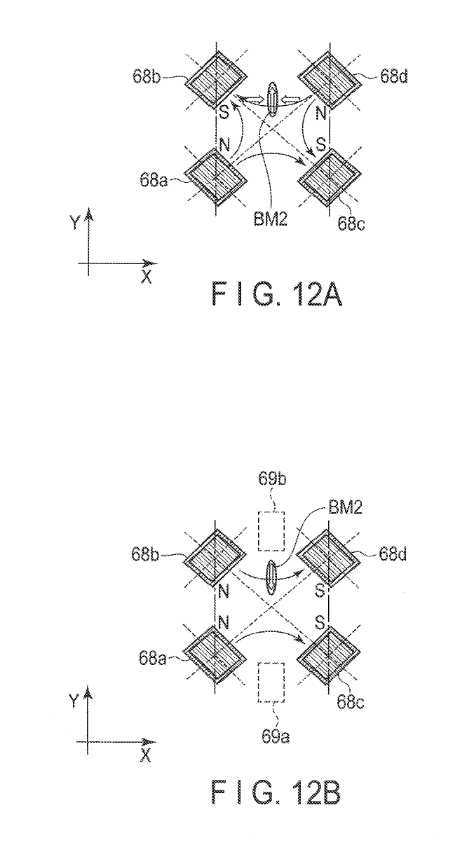

This specification explains the principle of the quadrupole magnetic field generation unit 60 of the present embodiment below with reference to the accompanying drawings. FIG. 12A shows the principle of a quadrupole magnetic field according to the third embodiment. FIG. 12B shows the principle of the dipoles according to the second embodiment. In FIG. 12A and FIG. 12B, an X-direction and a Y-direction are directions perpendicular to the direction in which an electron beam is emitted, and are perpendicular to each other. The X-direction is a direction from the magnetic pole 68b (magnetic pole 68a) side to the magnetic pole 68d (magnetic pole 68c) side. The Y-direction is a direction from the magnetic pole 68a (magnetic pole 68c) side to the magnetic pole 68b (magnetic pole 68d) side.

In FIG. 12A and FIG. 12B, in a manner different from that of FIG. 3, FIG. 5 and FIG. 7, it is assumed that an electron beam BM1 travels from the far side to the front side of the drawings. In FIG. 12A and FIG. 12B, a pair of magnetic poles 68a and 68c is a dipole (a pair of magnetic poles). A pair of magnetic poles 68b and 68d is a dipole (a pair of magnetic poles). A pair of magnetic poles 68a and 68c generates a DC magnetic field going in a direction accordance with the X-diction. A pair of magnetic poles 68b and 68d generates a DC magnetic field accordance with the X-direction.

As shown in FIG. 12A, when the quadrupole magnetic generation unit 60 is not influenced by deflection coil unit 69a or 69b, it is assumed that the quadrupole magnetic generation unit 60 generates a north-pole magnetic field in magnetic pole 68a, generates a south-pole magnetic field in magnetic pole 68b, generates a south-pole magnetic field in magnetic pole 68c and generates a north-pole magnetic field in magnetic pole 68d.

As shown in FIG. 12B, it is assumed that deflection coil unit 69a generates a north-pole magnetic field in magnetic pole 68a and generates a south-pole magnetic field in magnetic pole 68c. Similarly, deflection coil unit 69b generates a north-pole magnetic field in magnetic pole 68b and generates a south-pole magnetic field in magnetic pole 68d. Thus, a magnetic field from magnetic pole 68a to magnetic pole 68c and a magnetic field from magnetic pole 68b to magnetic pole 68d are formed by deflection coil units 69a and 69b, respectively.

In the quadrupole magnetic field generation unit 60, because of the effect of the magnetic fields of deflection coil units 69a and 69b shown in FIG. 12B, the magnetic field generated in deflection coil unit 69a is superimposed on the magnetic field having a direction from magnetic pole 68a to magnetic pole 68c. Further, the magnetic field generated in deflection coil unit 69b is superimposed on the magnetic field having a direction from magnetic pole 68d to magnetic pole 68b. Thus, the quadrupole magnetic field generation unit 60 generates a superimposed magnetic field from magnetic pole 68a to magnetic pole 68c in addition to the magnetic fields of the quadrupole. Here, the magnetic fields between magnetic poles 68b and 68d are cancelled by each other.

In the present embodiment, when the X-ray tube device 1 is driven, electrons are emitted from the filament included in the cathode 36 to the focal spot of the electrons on the anode target 35. Here, the direction in which electrons are emitted is assumed to be parallel to the straight line passing through the center of the cathode 36. Inclinations γ1 to γ4 of magnetic poles 68a to 68d of the quadrupole magnetic field generation unit 60 shown in FIG. 11B are the same as each other. In the quadrupole magnetic field generation unit 60, an electric source (not shown) supplies direct current to coils 64. When direct current is supplied from the electric source, the quadrupole magnetic field generation unit 60 generates a magnetic field between magnetic poles 68a to 68d as a quadruple. The electron beam emitted from the cathode 36 collides with the anode target 35 so as to cross the magnetic field generated between either the cathode 36 or the cathode supporting unit 37 and the anode target 35 along the tube axis TA. At this time, the shape of the electron beam is formed (focused) by the magnetic field generated by the quadrupole magnetic field generation unit 60. In the present embodiment, for example, as shown in FIG. 3, the quadrupole magnetic field generation unit 60 changes the shape of the electron beam roundly emitted to an elliptical shape which is slender in the Y-direction (in other words, the quadrupole magnetic field generation unit 60 focuses the electron beam into an elliptical shape which is slender in the Y-direction). In this case, the quadrupole magnetic field generation unit 60 is capable of reducing the size of the apparent focal spot of the electron beam and increasing the size of the actual focal spot of collision on the anode target 35 surface. As a result, thermal load for the anode target 35 is reduced.

In the present embodiment, the X-ray tube device 1 comprises the X-ray tube 30 comprising concave portions 32a to 32d, and the quadrupole magnetic field generation unit 60 comprising deflection coil units 69a and 69b. The quadrupole magnetic field generation unit 60 is capable of generating a superimposed magnetic field when an electric source supplies direct current to deflection coil units 69a and 69b. In the first embodiment, an electron beam is deflected in a single direction by providing the quadrupole magnetic field generation unit 60 eccentrically with respect to the path of an electron beam in a perpendicular direction. However, in the present embodiment, the quadrupole magnetic field generation unit 60 is capable of performing correction by deflecting the movement (deflection or eccentricity) in the length direction (Y-direction) caused when the shape of an electron beam is changed in the width direction (X-direction). In this way, the X-ray tube device 1 of the present embodiment is capable of magnetically changing the shape of an electron beam to an optimal shape in accordance with the intended use.

In the X-ray tube device 1 of the present embodiment, the distance between the anode target 35 and the cathode 36 is less than that of the above embodiments. Thus, the X-ray tube device 1 of the present embodiment is capable of reducing the expansion, blurring or distortion of an X-ray focal spot and preventing the reduction in the amount of emission of electrons in the cathode 36.

The X-ray tube device 1 of the present embodiment may further comprise deflection coil units 69c and 69d. When an electric source (not shown) supplies current to deflection coil units 69c and 69d (a third deflection coil unit and a fourth deflection coil unit), deflection coil units 69c and 69d generate a magnetic field. In the present embodiment, when an electric source (not shown) supplies direct current to deflection coil units 69c and 69d, deflection coil units 69c and 69d generate a DC magnetic field. Each of deflection coil units 69c and 69d is wound onto the portion between adjacent ones of projection portions 66a to 66d of the main unit of the yoke 66. For example, deflection coil unit 69c is wound onto the main unit of the yoke 66 between projection portions 66a and 66b. Deflection coil unit 69d is wound onto the main unit of the yoke 66 between projection portions 66c and 66d. In this case, a pair of magnetic poles 68a and 68b generates a DC magnetic field between them. A pair of magnetic poles 68c and 68d generates a DC magnetic field between them.

Deflection coil units 69c and 69d generate a dipole magnetic field formed in the radial direction of the anode target 35, in other words, a direction parallel to the length direction perpendicular to the width direction of the filament included in the cathode 36. Deflection coil units 69c and 69d are capable of deflecting the path of an electron beam to a predetermined direction by flowing current.

In the present embodiment, the quadrupole magnetic field generation unit 60 may comprise deflection coil units 69a, 69b, 69c and 69d. At this time, alternating current may be supplied from an electric source to deflection coil units 69a to 69d. In this case, the quadrupole magnetic field generation unit 60 generates dipole AC magnetic fields such that the magnetic fields generated from two pairs of magnetic poles have the same direction.

When alternating current is supplied to deflection coil units 69a and 69b, for example, the quadrupole magnetic field generation unit 60 comprises a pair of magnetic poles 68a and 68c and a pair of magnetic poles 68b and 68d. A pair of magnetic poles 68a and 68c and a pair of magnetic poles 68b and 68d each form a magnetic field as a dipole. A pair of magnetic poles 68a and 68c and a pair of magnetic poles 68b and 68d each form an AC magnetic field between them.

When alternating current is supplied to deflection coil units 69c and 69d, for example, the quadrupole magnetic field generation unit 60 comprises a pair of magnetic poles 68a and 68b and a pair of magnetic poles 68c and 68d. A pair of magnetic poles 68a and 68b and a pair of magnetic poles 68c and 68d each form a magnetic field as a dipole. A pair of magnetic poles 68a and 68b and a pair of magnetic poles 68c and 68d each form an AC magnetic field between them.

The quadrupole magnetic field generation unit 60 is capable of intermittently or continuously deflecting the path of electrons by the AC magnetic fields generated between the dipoles when alternating current is supplied. In the quadrupole magnetic field generation unit 60, the alternating current supplied from an electric source (not shown) to each of deflection coil units 69a to 69d described later is controlled by a deflection electric source controller (not shown) such that the focal spot of collision with the electron beam emitted from the cathode 36 is intermittently or continuously moved. The quadrupole magnetic field generation unit 60 is capable of deflecting the electron beam emitted from the cathode 36 to a direction parallel to the radial direction of the anode target 35. Thus, the quadrupole magnetic field generation unit 60 is capable of moving the position of the focal spot on the surface of the anode target 35 with which an electron beam collides.

Further, the X-ray tube device 1 of the present embodiment may comprise a first quadrupole magnetic field generation unit comprising deflection coil units 69a and 69b, and a second quadrupole magnetic field generation unit comprising deflection coil units 69c and 69d. In this case, the quadrupole magnetic field generation unit 60 may deflect the electron beam emitted from the cathode 36 to an arbitrary direction of the anode target 35.

According to the above embodiments, each X-ray tube device 1 comprises an X-ray tube comprising a plurality of concave portions, and a quadrupole magnetic field generation unit which forms the electron beam to be emitted in the X-ray tube. The quadrupole magnetic field generation unit generates magnetic fields between a plurality of magnetic poles when direct current is supplied from an electric source to coils. The quadrupole magnetic field generation unit is capable of changing the shape of the electron beam emitted from a cathode by the magnetic fields generated by the plurality of magnetic poles. As a result, each X-ray tube device 1 of the embodiments is allowed to reduce the expansion, blurring or distortion of an X-ray focal spot and prevent the reduction in the amount of emission of electrons of the cathode.

In the above embodiments, each X-ray tube device 1 is a rotating anode X-ray tube. However, each X-ray tube device 1 may be a fixed anode X-ray tube.

In the above embodiments, each X-ray tube device 1 is a neutral grounded X-ray tube device. However, each X-ray tube device 1 may be an anode grounded or cathode grounded X-ray tube device.

In the above embodiments, the cathode 36 comprises a nonmagnetic cover surrounding the outer circumferential portion. However, they may be entirely formed of a nonmagnetic material or a nonmagnetic metal material having a high electric conductivity as an integral structure.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An X-ray tube device comprising:
a cathode which emits an electron in a direction of an electron path;
an anode target which faces the cathode and comprises a target surface generating an X-ray when the electron emitted from the cathode collides with the target surface;
a vacuum envelope which accommodates the cathode and the anode target and is sealed in a vacuum-tight manner; and
a quadrupole magnetic field generation unit which forms a magnetic field when direct current is supplied from an electric source, is eccentrically provided with respect to a straight line accordance with the electron path outside the vacuum envelope, and comprises a quadrupole surrounding a circumference of a part of the electron path.

2. The X-ray tube device of claim 1, wherein
the vacuum envelope further comprises an accommodation unit extending to an external side at a position facing the anode target, accommodating the cathode, and comprising a small radial portion having a radius less than a peripheral radius between the anode target and the cathode, and
the quadrupole magnetic field generation unit surrounds a periphery of the small radial portion.

3. The X-ray tube device of claim 1, wherein
the vacuum envelope comprises a concave portion hollowed from an external side, and
the quadrupole is accommodated in the concave portion.

4. The X-ray tube device of claim 1, further comprising
at least one deflection coil unit to which alternating current is supplied from an AC source, the deflection coil unit being provided in a part of the quadrupole magnetic field generation unit, and constituting at least one pair of dipoles generating an AC magnetic field in the quadrupole in the quadrupole magnetic field generation unit.

5. The X-ray tube device of claim 4, wherein
in the cathode and the target surface, at least a surface portion is formed of a nonmagnetic metal material having a high electric conductivity.

6. The X-ray tube device of claim 5, wherein
the metal material is one of copper, tungsten, molybdenum, niobium, tantalum and nonmagnetic stainless steel, or contains one of them as a main component.

7. The X-ray tube device of claim 3, wherein
each end surface of the quadrupole of the quadrupole magnetic field generation unit is provided such that an angle with respect to the electron path is a predetermined inclined angle γ, and
the inclined angle γ is in a range of 0′<γ<90°.
